(19) United States
(12) Patent Application Publication
(10) Pub. No.: US 2025/0257879 A1
(43) Pub. Date: Aug. 14, 2025

(54) COOKING APPLIANCE

(71) Applicant: SAMSUNG ELECTRONICS CO., LTD., Suwon-si (KR)

(72) Inventors: Wangi PARK, Suwon-si (KR); Jaemin PARK, Suwon-si (KR)

(73) Assignee: SAMSUNG ELECTRONICS CO., LTD., Suwon-si (KR)

(21) Appl. No.: 19/191,518

(22) Filed: Apr. 28, 2025

Related U.S. Application Data
(63) Continuation of application No. PCT/KR2023/016375, filed on Oct. 20, 2023.

(30) Foreign Application Priority Data
Nov. 24, 2022 (KR) 10-2022-0159661
Jan. 20, 2023 (KR) 10-2023-0008916

(51) Int. Cl. F24C 15/02; E05D 11/10

(52) U.S. Cl. CPC F24C 15/022; E05D 11/1007; F24C 15/023

(57) ABSTRACT

A cooking appliance including a main body forming a cooking chamber; a door configured to open and close the cooking chamber; and a hinge assembly which connects the main body and the door, wherein the hinge assembly includes a door bracket coupled to the door, a main body bracket coupled to the main body, a hinge link that connects the door bracket and the main body bracket, and supports the door bracket so as to be rotatable, and a locking member coupled to the hinge link. When the cooking chamber is closed by the door, the engaging portion is engaged with the main body bracket to fix a position of the door bracket, and, to prevent the engaging portion from deviating from the main body bracket, the deviation prevention portion interferes with the door bracket if the engaging portion moves in a direction away from the main body bracket.

This application is a continuation application of International Application No. PCT/KR2023/016375, filed on Oct. 20, 2023, which is based on and claims the benefit of Korean Patent Application Number 10-2022-0159661, filed on Nov. 24, 2022, and Korean Patent Application Number 10-2023-0008916, filed on Jan. 20, 2023, the disclosures of which are incorporated by reference herein in their entireties.

### TECHNICAL FIELD

The present disclosure relates to a cooking apparatus having a hinge connecting a main body and a door.

### BACKGROUND ART

Cooking apparatuses are apparatuses for cooking by heating a cooking object such as food, and refer to apparatuses capable of providing various functions related to cooking, such as heating, thawing, drying, and sterilization of a cooking object. Cooking apparatuses include, for example, an oven such as a gas oven and an electric oven, a microwave heating device (hereinafter referred to as a microwave oven), a gas range, an electric range, a hood combined microwave oven (Over the Range, or OTR), a gas grill or an electric grill, and the like.

Ovens are apparatuses that cook food by directly transferring heat to the food through a heating source such as a heater or by heating the inside of a cooking chamber. Microwave ovens are apparatuses that cook food by frictional heat generated between molecules by disturbing a molecular arrangement of the food using high frequency as a heating source.

An oven includes a cooking chamber for cooking food and an electrical room for storing electrical components. The inside of the cooking chamber is sealed to prevent high temperature heat from escaping to the outside in a process of cooking food.

An oven includes a main body forming a cooking chamber and an electrical room inside, and a door for opening and closing the cooking chamber. The door may be rotatably supported by a hinge connecting the door and the main body.

### Disclosure

An embodiment of the present disclosure is directed to providing a cooking apparatus having an improved structure so that a door of the cooking apparatus may be stably supported by a hinge assembly.

An embodiment of the present disclosure is directed to providing a cooking apparatus having an improved structure to prevent a door from deviating from a designed position.

An embodiment of the present disclosure is directed to providing a cooking apparatus having an improved structure such that the external quality of a product is improved.

An embodiment of the present disclosure is directed to providing a cooking apparatus having an improved structure such that a hinge link of a hinge assembly may be stably supported on a main body bracket.

An embodiment of the present disclosure is directed to providing a cooking apparatus having an improved structure to prevent noise or vibration from occurring when a door rotates relative to a main body.

Technical tasks to be achieved in this document are not limited to the technical tasks mentioned above, and other technical tasks not mentioned will be clearly understood by those skilled in the art to which the present invention belongs from the description below.

Aspects of embodiments of the disclosure will be set forth in part in the description which follows and, in part, will be apparent from the description, or may be learned by practice of the presented embodiments.

According to an embodiment of the disclosure, a cooking apparatus including a main body forming a cooking chamber; a door configured to open and close the cooking chamber; and a hinge assembly which connects the main body and the door, wherein the hinge assembly includes a door bracket coupled to the door, a main body bracket coupled to the main body, a hinge link that connects the door bracket and the main body bracket, and supports the door bracket so as to be rotatable, and a locking member coupled to the hinge link, and including an engaging portion, and a deviation prevention portion, wherein the locking member is configured so that, when the door is positioned to close the cooking chamber, the engaging portion is engaged with the main body bracket to fix a position of the door bracket, and, to prevent the engaging portion from deviating from the main body bracket, the deviation prevention portion is positioned to interfere with the door bracket based on movement of the engaging portion in a direction away from the main body bracket.

According to an embodiment of the disclosure, the main body bracket may include an insertion portion. When the door is positioned to close the cooking chamber, at least a portion of the engaging portion may be inserted into the insertion portion.

According to an embodiment of the disclosure, when the door is positioned to close the cooking chamber, a distance between the door bracket and the main body bracket may be shorter than a distance between an end of the engaging portion in a direction of being inserted into the insertion portion and an end of the deviation prevention portion positioned to interfere with the door bracket.

According to an embodiment of the disclosure, when the door is positioned to close the cooking chamber, the locking member may be configured to be positioned between a first position in which the engaging portion is maximally inserted into the insertion portion and a second position in which the engaging portion moves in a direction away from the insertion portion, and the deviation prevention portion may be configured to come into contact with the door bracket when the locking member is in the second position.

According to an embodiment of the disclosure, the deviation prevention portion may extend in a direction away from a tip configured to contact the door bracket when the locking member is in the second position.

According to an embodiment of the disclosure, the locking member may include a locking body coupled to the hinge link. The engaging portion may protrude from the locking body toward an inner side of the insertion portion.

According to an embodiment of the disclosure, the locking member may include a locking body coupled to the hinge link. The deviation prevention portion may protrude from the locking body in the direction away from the main body bracket.

According to an embodiment of the disclosure, the cooking apparatus may further include a coupling shaft coupling the locking member to the hinge link. The locking member may be configured to be rotatable relative to the hinge link about the coupling shaft.

According to an embodiment of the disclosure, a distance from the coupling shaft to the deviation prevention portion may be shorter than a distance from the coupling shaft to the engaging portion.

According to an embodiment of the disclosure, the deviation prevention portion may include a plurality of deviation prevention portions disposed to be spaced apart from each other. The locking member may include a plurality of extension portions extending respectively from the plurality of deviation prevention portions to the engaging portion. The engaging portion may connect the plurality of extension portions to each other.

According to an embodiment of the disclosure, the engaging portion may include a plurality of engaging portions separated from each other. The locking member may include a plurality of extension portions extending respectively from a plurality of the engaging portions, toward the deviation prevention portion. The deviation prevention portion may connect the plurality of extension portions to each other.

According to an embodiment of the disclosure, a cooking apparatus may include a main body forming a cooking chamber, a door configured to open and close the cooking chamber, and a hinge assembly which connects the main body and the door. The hinge assembly may include a door bracket coupled to the door, a main body bracket coupled to the main body, and a hinge link configured to connect the door bracket and the main body bracket and support the door bracket such that the door bracket is rotatable relative to the main body bracket, and having at least a portion accommodated in the main body bracket. The main body bracket may include a protrusion portion formed to protrude toward the at least a portion of the hinge link accommodated in the main body bracket to prevent the hinge link from moving.

According to an embodiment of the disclosure, a cooking apparatus may include a main body forming a cooking chamber, a door configured to open and close the cooking chamber, and a hinge assembly which connects the main body and the door. The hinge assembly may include a door bracket coupled to the door, a main body bracket coupled to the main body, a hinge link configured to connect the door bracket and the main body bracket and support the door bracket such that the door bracket is rotatable relative to the main body bracket, a first supporter configured to support one side of the hinge link to prevent the hinge link from rotating in a first direction relative to the main body bracket, and a second supporter configured to support another side of the hinge link to prevent the hinge link from rotating in a second direction opposite to the first direction relative to the main body bracket.

### DESCRIPTION OF DRAWINGS

These and/or other aspects of the disclosure will become apparent and more readily appreciated from the following description of embodiments, taken in conjunction with the accompanying drawings listed below.

FIG. 1 is a front view of a cooking apparatus according to an embodiment of the present disclosure.

FIG. 2 is a perspective view of the cooking apparatus according to an embodiment of the present disclosure.

FIG. 3 is a view illustrating a hinge assembly of the cooking apparatus according to an embodiment of the present disclosure.

FIG. 4 is a view illustrating the hinge assembly of the cooking apparatus according to an embodiment of the present disclosure.

FIG. 5 is an enlarged view of a portion of FIG. 4.

FIG. 6 is a view illustrating that a locking member is moved in the hinge assembly of FIG. 5.

FIG. 7 is a view illustrating the locking member included in the hinge assembly of the cooking apparatus according to an embodiment of the present disclosure.

FIG. 8 is an enlarged view of some components of a hinge assembly of the cooking apparatus according to an embodiment of the present disclosure.

FIG. 9 is a view illustrating that a locking member is moved in the hinge assembly of FIG. 8.

FIG. 10 is a view illustrating the locking member included in the hinge assembly of the cooking apparatus according to an embodiment of the present disclosure.

FIG. 11 is a view illustrating that some components of a hinge assembly of a cooking apparatus according to an embodiment of the present disclosure are exploded.

FIG. 12 is a view illustrating a process of manufacturing the hinge assembly of the cooking apparatus according to an embodiment of the present disclosure.

FIG. 13 is a view illustrating a process of manufacturing the hinge assembly of the cooking apparatus according to an embodiment of the present disclosure.

FIG. 14 is an enlarged cross-sectional view illustrating that the hinge assembly of the cooking apparatus according to an embodiment of the present disclosure is cut in a transverse direction and enlarged.

FIG. 15 is an enlarged cross-sectional view illustrating that the hinge assembly of the cooking apparatus according to an embodiment of the present disclosure is cut in the transverse direction and enlarged.

FIG. 16 is an enlarged cross-sectional view illustrating that the hinge assembly of the cooking apparatus according to an embodiment of the present disclosure is cut in the transverse direction and enlarged.

FIG. 17 is a view illustrating a hinge assembly when a door closes a cooking chamber in the cooking apparatus according to an embodiment of the present disclosure.

FIG. 18 is a view illustrating the hinge assembly when the door partially opens the cooking chamber in the cooking apparatus according to an embodiment of the present disclosure.

FIG. 19 is an enlarged view of some components of the hinge assembly of the cooking apparatus according to an embodiment of the present disclosure.

FIG. 20 is an enlarged view of some components of the hinge assembly of the cooking apparatus according to an embodiment of the present disclosure.

FIG. 21 is an enlarged view of some components of the hinge assembly of the cooking apparatus according to an embodiment of the present disclosure.

FIG. 22 is an enlarged view of some components of the hinge assembly of the cooking apparatus according to an embodiment of the present disclosure.

FIG. 23 is an enlarged view of some components of a hinge assembly of the cooking apparatus according to an embodiment of the present disclosure.

FIG. 24 is an enlarged view of some components of a hinge assembly of the cooking apparatus according to an embodiment of the present disclosure.

### MODE OF THE DISCLOSURE

The embodiments described in the present specification and the configurations shown in the drawings are only examples of preferred embodiments of the present disclosure, and various modifications may be made at the time of filing of the present disclosure to replace the embodiments and drawings of the present specification.

Like reference numbers or signs in the various drawings of the application represent parts or components that perform substantially the same functions.

The terms used in the present specification are for the purpose of describing the embodiments and are not intended to restrict and/or to limit the present disclosure. For example, the singular expressions herein may include plural expressions, unless the context clearly dictates otherwise. Also, the terms “includes” and “has” are intended to indicate that there are features, numbers, steps, operations, components, parts, or combinations thereof described in the specification, and do not exclude the presence or addition of one or more other features, numbers, steps, operations, components, parts, or combinations thereof.

It will be understood that, although the terms “first,” “second,” and the like may be used herein to describe various components, these components should not be limited by these terms, these terms are only used to distinguish one component from another. For example, without departing from the scope of the present disclosure, a first component may be referred to as a second component, and similarly, the second component may also be referred to as a first component. The term “and/or” includes any combination of a plurality of related items or any one of a plurality of related items.

The terms “upward,” “downward,” “forward,” “rearward,” “left side,” and “right side,” etc., used in the following description are defined with reference to the drawings, and the shape and position of each component are not limited by these terms. For example, the terms “upward” and “downward” may each be defined with respect to a Z direction illustrated in the drawings. For example, the terms “forward” and “rearward” below may refer to forward and rearward in an X direction with respect to the drawings, respectively. The following terms “upward,” “upper side,” “downward,” and “lower side” may refer to upward or upper side in the Z direction and downward or lower side in the Z direction with respect to the drawings, respectively. The terms “left side” and “right side” below may refer to left side in a Y direction and right side in the Y direction with respect to the drawings, respectively.

Hereinafter, embodiments of the present disclosure will be described in detail with reference to the accompanying drawings.

In addition, for convenience of explanation, the following description is made on the assumption that a cooking apparatus according to an embodiment of the present disclosure is an oven, but the present disclosure is not limited thereto and may be applied to various types of cooking apparatus such as microwave ovens.

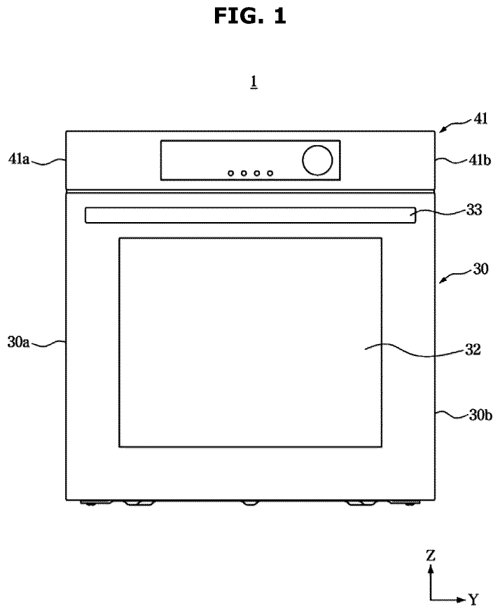

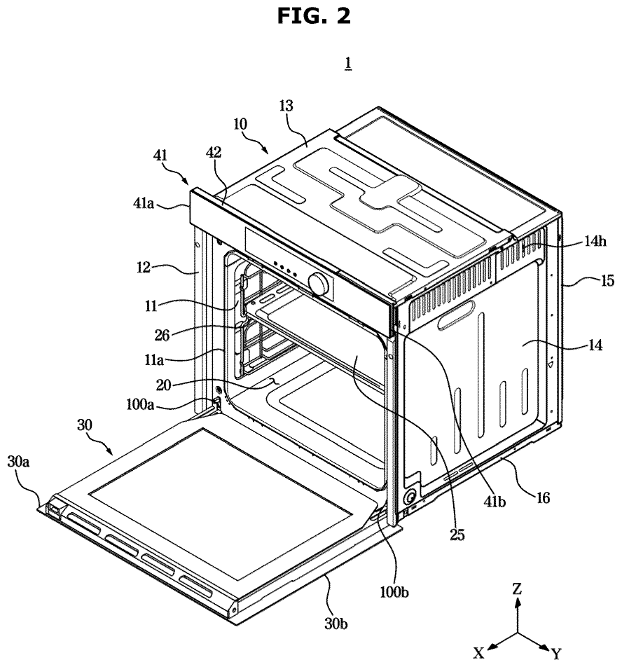

FIG. 1 is a front view of a cooking apparatus according to an embodiment of the present disclosure. FIG. 2 is a perspective view of the cooking apparatus according to an embodiment of the present disclosure.

Referring to FIGS. 1 and 2, a cooking apparatus 1 according to an embodiment of the present disclosure may include a cooking chamber 20, a main body 10 forming the cooking chamber 20, and a door 30 configured to open and close the cooking chamber 20.

The main body 10 may include an inner case 11 in which the cooking chamber 20 is formed. The inner case 11 may be provided inside outer cases 12, 13, 14a, 14b, 15, and 16 of the main body 10, which will be described later.

The cooking chamber 20 may be formed with an open front to allow food to be put in and taken out. The inner case 11 may include an opening 11a to allow food to enter and exit the cooking chamber 20 therethrough. One side of the main body 10 on which the opening 11a is formed may be defined as a front side of the main body 10.

As an example, the inner case 11 may have a box shape with a substantially open front.

An inner wall of the inner case 11 may be coated to prevent the inner wall of the inner case 11 from being corroded due to condensation that may occur in a condensation process of water vapor or moisture contained in food itself, etc. The inner wall of the inner case 11 may be dried by heat generated in a food cooking process.

Inside the cooking chamber 20, a plate 25 capable of receiving food and a rack 26 supporting the plate 25 may be provided. The plate 25 and the rack 26 may be configured to be inserted into or withdrawn from the cooking chamber 20 through the opening 11a of the inner case 11. As an example, the rack 26 may be configured to be inserted into the cooking chamber 20 or withdrawn from the cooking chamber 20 by sliding relative to the inner case 11.

In addition, inside the cooking chamber 20, a heater (not shown) to supply heat for cooking food, a cooking chamber fan (not shown) to allow air heated by the heater to flow smoothly inside the cooking chamber 20, etc., may be provided. However, the present disclosure is not limited thereto, and various configurations may be provided inside the cooking chamber 20 depending on a purpose and function of the cooking apparatus 1.

The cooking apparatus 1 may include an electrical room provided separately from the cooking chamber 20. The electrical room may be provided inside the main body 10. The inner case 11 may partition the cooking chamber 20 and the electrical room (not shown).

The electrical room may be formed to surround the inner case 11. The electrical room may insulate a space between the cooking chamber 20 and the outer case of the main body 10 to prevent heat inside the cooking chamber 20 from being emitted directly to the outside of the main body 10. Air may flow for insulation in the electrical room. In the electrical room, a separate insulator (not shown) may be provided to surround the inner case 11 for insulation. The insulator may be composed of materials such as fiberglass and asbestos.

In the electrical room, various electrical components such as a printed circuit board (not shown) to control an operation of the cooking apparatus 1 may be disposed. Depending on an embodiment, a steam generator (not shown) to generate steam may be provided in the electrical room. Depending on an embodiment, an automatic opening and closing device (not shown) to automatically open and close the door 30 may be provided in the electrical room.

A cooling fan module (not shown) may be provided inside the electrical room to cool heat generated from various electrical components.

The main body 10 may include the outer cases 12, 13, 14a, 14b, 15, and 16 configured to form at least portion of an appearance of the cooking apparatus 1. The cooking chamber 20 and the electrical room may be disposed inside the outer cases of the main body 10.

The outer case of the main body 10 may include an upper panel 13 forming an upper surface of the cooking apparatus 1. The upper panel 13 may cover an upper part of the electrical room.

The outer cases of the main body 10 may include side panels 14 forming left and right surfaces of the cooking apparatus 1. As an example, the side panels 14 may be provided with heat dissipation holes 14h formed to dissipate heat inside the electrical room.

The outer case of the main body 10 may include a rear panel 15 forming a rear surface of the cooking apparatus 1. As an example, the rear panel 15 may be provided with a heat dissipation hole (not shown) formed to dissipate heat inside the electrical room.

The outer case of the main body 10 may include a base 16 forming a bottom surface of the cooking apparatus 1.

The upper panel 13, the side panels 14, the rear panel 15, and the base 16 may each be formed to have a substantially flat plate shape, but the shape thereof is not limited thereto.

The main body 10 may include a front frame 12 forming at least a portion of a front surface of the main body 10. The front frame 12 may be provided on a front side of the main body 10. The front frame 12 may be covered by the door 30 when the door 30 is closed.

The front frame 12 may be formed in the shape of a frame having an opening. The front frame 12 may be formed along a circumference of the opening 11a of the inner case 11.

As an example, the inner case 11 may be coupled to the front frame 12, and a portion of the inner case 11 adjacent to the opening 11a may be coupled to the front frame 12.

The front frame 12 may be coupled to the upper panel 13. The front frame 12 may be coupled to each of the left and right side panels of the side panels 14. The front frame 12 may be coupled to the base 16. The front frame 12 may be coupled to a control panel bracket 42, which will be described later.

The front frame 12, the upper panel 13, the side panels 14, the rear panel 15 and the base 16 may be detachably coupled to each other. However, the present disclosure is not limited thereto, and each of the front frame 12, the upper panel 13, the side panels 14, and the base 16 may have only a portion thereof that is detachable, while the other portions may be formed integrally with each other.

The cooking apparatus 1 may include a control panel 41. The control panel 41 may include a display capable of displaying a variety of operation information of the cooking apparatus 1 and an inputter capable of allowing a user to input operation commands. The inputter may be provided as a touch panel. The inputter may include buttons or knobs.

As an example, the control panel 41 may be provided on an upper portion of a front surface of the cooking apparatus 1.

The cooking apparatus 1 may include the control panel bracket 42 on which the control panel 41 is mounted. The control panel bracket 42 may be coupled to the main body 10. In detail, the control panel bracket 42 may be coupled to the front of the main body 10. The control panel bracket 42 may be coupled to an upper portion of the front frame 12.

The control panel 41 may be mounted on the control panel bracket 42. The control panel 41 may be mounted on a front surface of the control panel bracket 42. The control panel bracket 42 may include an opening (not shown) to allow at least a portion of a rear surface of the control panel 41 to be cooled by the cooling fan module provided in the electrical room.

The cooking apparatus 1 may include the door 30 configured to open and close the cooking chamber 20. The door 30 may be rotatably coupled to the main body 10 to open and close the cooking chamber 20. As an example, the door 30 may be rotatably coupled to a lower portion of the main body 10 and may be rotatable about a rotation shaft provided at a lower portion of the cooking apparatus 1.

The door 30 may include a transparent portion 32 formed transparently to allow the user to see into the inside of the cooking chamber 20 even when the door 30 closes the cooking chamber 20. The transparent portion 32 may include various transparent materials such as glass materials.

The door 30 may include a handle 33 to enable the user to manually open and close the door 30. To enable the user to easily open and close the door 30, the handle 33 may be provided adjacent to a portion of the door 30 opposite to the rotation shaft of the door 30. FIG. 1 illustrates an example in which the handle 33 is provided on a front surface of the door 30, but is not limited thereto. Herein, ‘the front surface of the door 30’ refers to a surface of the door 30 facing forward in an X direction based on a state in which the door 30 closes the cooking chamber 20.

The cooking apparatus 1 may include a hinge assembly 100 configured to connect the door 30 and the main body 10. The hinge assembly 100 may be coupled to each of the door 30 and the main body 10. The hinge assembly 100 may support the door 30 so that the door 30 may rotate relative to the main body 10.

The hinge assembly 100 may include a plurality of hinge assemblies 100a and 100b. As an example, as illustrated in FIG. 2, the plurality of hinge assemblies 100a and 100b may be coupled to left and right lower portions of the main body 10, respectively, and may be coupled to left and right lower portions of the door 30, respectively. That is, the left hinge assembly 100a may connect the left lower portion of the door 30 to the left lower portion of the main body 10, and the right hinge assembly 100b may connect the right lower portion of the door 30 to the right lower portion of the main body 10. Herein, the ‘lower portion’ of the door 30 refers to a portion positioned at a lower portion of the door 30 in a Z direction when the cooking chamber 20 is closed.

As an example, as illustrated in FIG. 2, the rotation shaft of the door 30 may be provided at the lower portion of the cooking apparatus 1 and may extend in a left-right direction of the cooking apparatus 1 which is a Y direction.

The configurations of the cooking apparatus 1 described above with reference to FIGS. 1 and 2 are merely examples of the cooking apparatus according to the present disclosure, and the present disclosure is not limited thereto.

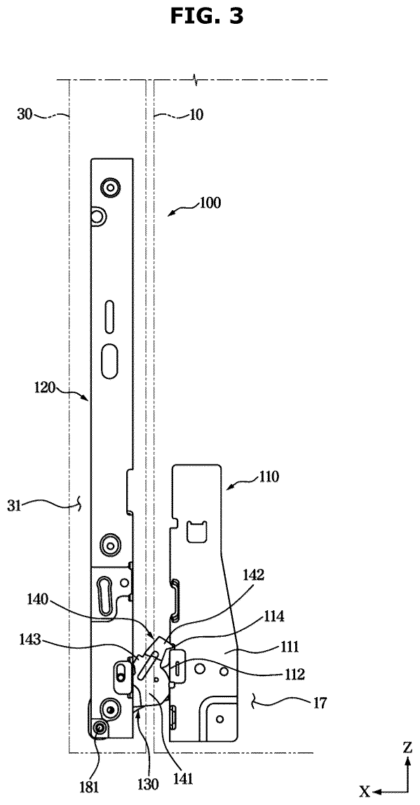

Hereinafter, hinge assemblies of the cooking apparatus 1 according to embodiments of the present disclosure will be described in detail with reference to FIGS. 3 to 24. FIGS. 3 to 24 illustrate the hinge assemblies of the cooking apparatus 1 according to the embodiments of the present disclosure based on the right hinge assembly 100b for convenience, but the following description may also be applied to the left hinge assembly 100a.

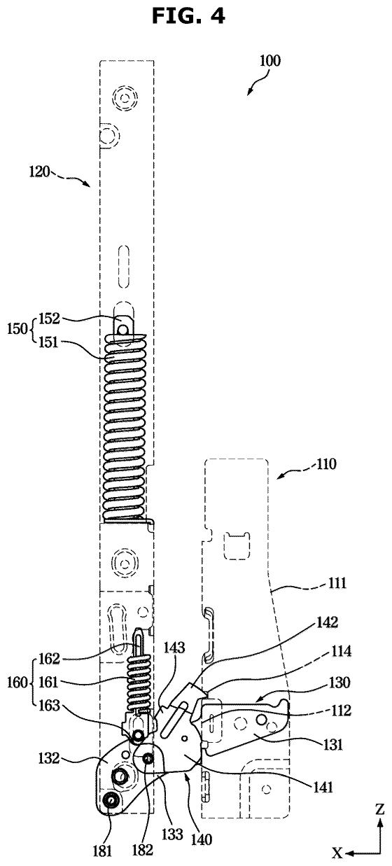

FIG. 3 is a view illustrating a hinge assembly of the cooking apparatus according to an embodiment of the present disclosure. FIG. 4 is a view illustrating the hinge assembly of the cooking apparatus according to an embodiment of the present disclosure.

Referring to FIGS. 3 and 4, the hinge assembly 100 of the cooking apparatus 1 according to an embodiment of the present disclosure may connect the door 30 and the main body 10. The hinge assembly 100 may rotatably support the door 30 relative to the main body 10.

In detail, the hinge assembly 100 may include a main body bracket 110 configured to be coupled to the main body 10. The main body bracket 110 may be fixed to the main body 10 and may be maintained in a fixed position relative to the main body 10 regardless of whether the door 30 opens or closes the cooking chamber 20.

As an example, the main body bracket 110 may be fixed by being screw-fastened to some of the outer cases of the main body 10 (e.g., the base 16 or the side panel 14, etc.).

As an example, the main body bracket 110 may be fixed by being screw-fastened to the front frame 12 of the main body 10.

However, the present disclosure is not limited thereto, and the main body bracket 110 may be fixed to the main body 10 in various methods.

The main body 10 may include a main body hinge mounting portion 17 on which the main body bracket 110 is mounted. The main body bracket 110 is mounted on the main body hinge mounting portion 17 to be maintained in the fixed position relative to the main body 10.

The main body hinge mounting portion 17 may be provided on each of left and right portions of the main body 10.

The main body hinge mounting portion 17 may be formed between the inner case 11 and the outer case of the main body 10. As an example, the main body hinge mounting portion 17 may be formed between the inner case 11, the side panels 14, and the front frame 12.

The main body bracket 110 may support a hinge link 130, which will be described later. At least a portion of the hinge link 130 may be accommodated in the main body bracket 110.

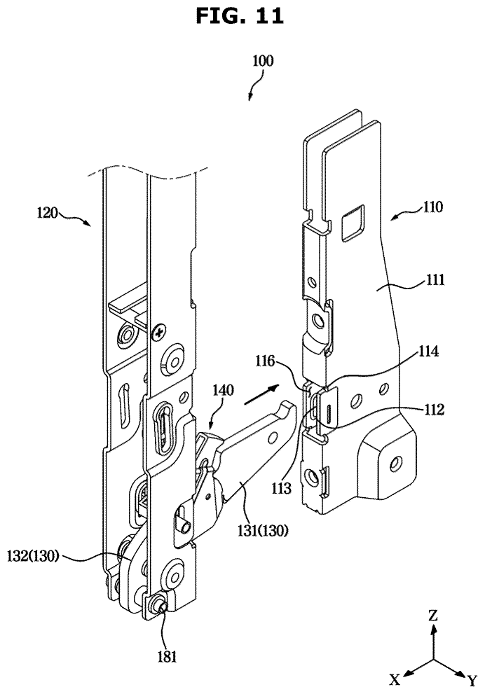

The main body bracket 110 may include a cover portion 111 to cover at least a portion of the hinge link 130 accommodated in the main body bracket 110. An accommodation space 116 (see FIG. 11) of the main body bracket 110, in which at least a portion of the hinge link 130 is accommodated, may be formed on an inner side of the cover portion 111.

The cover portion 111 may be coupled to the main body 10. As an example, the cover portion 111 may be screw-fastened to the main body 10 so that the main body bracket 110 may be fixed to the main body 10.

As an example, the cover portion 111 may include a pair of side plates disposed opposite each other, and a front plate connecting the pair of side plates. The pair of side plates of the cover portion 111 may be arranged to face each other in the Y direction. The front plate of the cover portion 111 may extend in the Y direction to connect the pair of side plates. The front plate of the cover portion 111 may connect a front portion of each of the pair of side plates in the X direction. The front plate of the cover portion 111 may be provided at one end of the main body bracket 110 facing a door bracket 120 when the door 30 closes the cooking chamber 20, that is, at one end of the cover portion 111 on the door bracket 120 side.

As an example, the pair of side plates of the cover portion 111 and the front plate connecting the side plates may be formed integrally.

The main body bracket 110 may include a coupling hole 112 formed to allow the hinge link 130 to penetrate in order for the hinge link 130 to be coupled to the main body bracket 110. The coupling hole 112 may be provided at one end of the cover portion 111 on the door bracket 120 side. That is, the coupling hole 112 may be provided on the front plate connecting the pair of side plates of the cover portion 111.

As an example, the main body bracket 110 may be composed of a metal material. However, the material of the main body bracket 110 is not limited thereto.

The main body bracket 110 described above is only an example of one configuration in which the hinge assembly of the cooking apparatus according to the present disclosure is coupled to the main body, and the present disclosure is not limited thereto.

Unlike what is illustrated, the main body bracket 110 may be formed integrally with a portion of the main body 10. That is, the hinge link 130, which will be described later, may be directly coupled to the main body 10, and a locking member 140, which will be described later, may be directly engaged with and coupled to the main body 10.

The hinge assembly 100 may include the door bracket 120 configured to be coupled to the door 30. The door bracket 120 may be configured to be fixed to the door 30 and to rotate together with the door 30 when the door 30 opens and closes the cooking chamber 20.

As an example, the door bracket 120 may be fixed by being screw-fastened to the door 30.

However, the present disclosure is not limited thereto, and the door bracket 120 may be fixed to the door 30 by various methods.

The door 30 may include a door hinge mounting portion 31 formed to allow the door bracket 120 to be mounted. The door bracket 120 may be mounted on the door hinge mounting portion 31 to be maintained in a fixed position relative to the door 30.

The door hinge mounting portion 31 may be provided on each of left and right portions of the door 30.

When the door 30 is in a position of closing the cooking chamber 20, the door hinge mounting portion 31 and the main body hinge mounting portion 17 may be arranged parallel to each other forward and backward in the X direction.

The door bracket 120 may be supported by the hinge link 130, which will be described later. The door bracket 120 may be rotatably supported by the hinge link 130. At least a portion of the hinge link 130 may be accommodated in the door bracket 120.

In detail, the door bracket 120 may be configured to be rotatable about a door rotation shaft 181. The door rotation shaft 181 may function as the rotation shaft of the door 30. The door bracket 120 and the hinge link 130 may be coupled by the door rotation shaft 181.

The door rotation shaft 181 may penetrate the door bracket 120 and the hinge link 130.

As an example, the door rotation shaft 181 may couple a lower portion of the door bracket 120 and a lower portion of the hinge link 130. The door rotation shaft 181 may extend in the Y direction.

As an example, the door bracket 120 may be composed of a metal material. However, the material of the door bracket 120 is not limited thereto.

The door bracket 120 described above is only an example of one configuration in which the hinge assembly of the cooking apparatus according to the present disclosure is coupled to the door, and the present disclosure is not limited thereto.

Unlike what is illustrated, the door bracket 120 may be formed integrally with a portion of the door 30. That is, the hinge link 130, which will be described later, may be directly coupled to the door 30.

The hinge link 130 may connect the main body bracket 110 and the door bracket 120. The hinge link 130 may be coupled to each of the main body bracket 110 and the door bracket 120. The hinge link 130 may rotatably support the door bracket 120.

The hinge link 130 may be coupled to the main body bracket 110. The main body bracket 110 may be maintained in a fixed position relative to the hinge link 130 regardless of the opening or closing of the door 30.

In detail, the hinge link 130 may include a main body coupling portion 131 coupled to the main body bracket 110. The hinge link 130 may be coupled to the main body bracket 110 by the main body coupling portion 131 and may be fixed to the main body bracket 110.

At least a portion of the main body coupling portion 131 may be accommodated in the main body bracket 110. At least a portion of the main body coupling portion 131 may be covered by the cover portion 111. The main body coupling portion 131 may be inserted into the main body bracket 110.

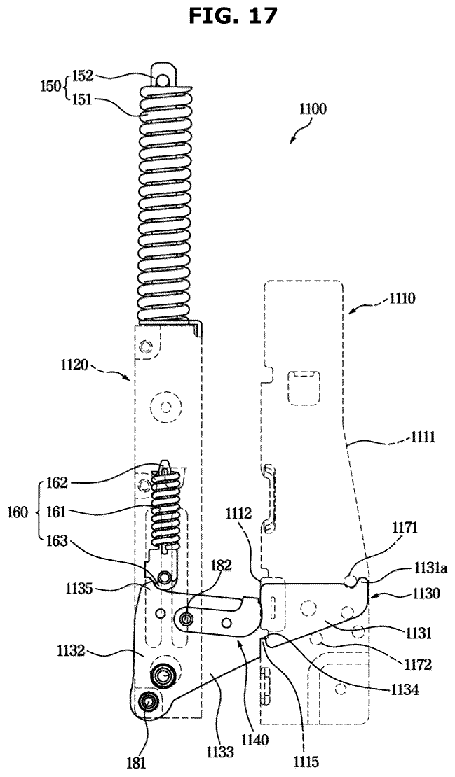

A specific structure for fixing the hinge link 130 to the main body bracket 110 will be described later (see FIGS. 17 to 24, etc.).

The hinge link 130 may be coupled to the door bracket 120. The door bracket 120 may be rotatably coupled to the hinge link 130.

As described above, the hinge link 130 may be coupled to the door bracket 120 by the door rotation shaft 181. The door bracket 120 may rotate relative to the hinge link 130 with the door rotation shaft 181 as a rotation axis.

In detail, the hinge link 130 may include a door coupling portion 132 coupled to the door bracket 120. The hinge link 130 may be coupled to the door bracket 120 by the door coupling portion 132. The door bracket 120 may be configured to be rotatable relative to the door coupling portion 132.

The door rotation shaft 181 may penetrate the door coupling portion 132 and the door bracket 120.

At least a portion of the door coupling portion 132 may be accommodated in the door bracket 120. At least a portion of the door coupling portion 132 may be covered by the door bracket 120.

The hinge link 130 may include an intermediate portion 133 provided between the main body coupling portion 131 and the door coupling portion 132.

The intermediate portion 133 may be located outside the main body bracket 110. The intermediate portion 133 may be located outside the door bracket 120 when the door 30 is in the position of closing the cooking chamber 20. That is, the intermediate portion 133 may be located between the main body bracket 110 and the door bracket 120 when the door 30 is in the position of closing the cooking chamber 20.

As an example, the main body coupling portion 131, the door coupling portion 132, and the intermediate portion 133 of the hinge link 130 may all be formed integrally.

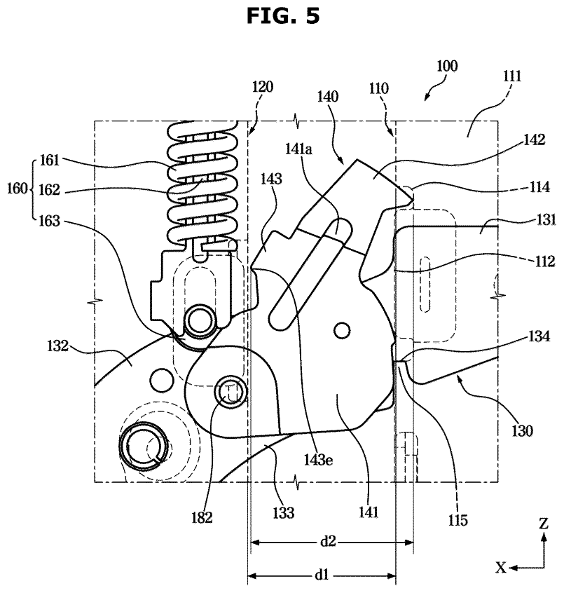

The main body bracket 110 may include a link support portion 115 (see FIG. 5) provided at one end of the main body bracket 110 on the door bracket 120 side to support the hinge link 130.

The link support portion 115 may support a portion of the hinge link 130 corresponding to a portion between the main body coupling portion 131 and the intermediate portion 133.

The link support portion 115 may be provided at a front end of the main body bracket 110 in the X direction. The link support portion 115 may be provided on the front plate connecting the pair of side plates of the cover portion 111.

The link support portion 115 may be provided adjacent to the coupling hole 112. As an example, the link support portion 115 may be provided below the coupling hole 112.

The link support portion 115 may support a lower side of the hinge link 130.

The hinge link 130 may include a support groove 134 (see FIG. 5) formed to correspond to the link support portion 115.

The support groove 134 may be formed to be engaged with and coupled to the link support portion 115. As an example, the support groove 134 may be formed on the lower side of the hinge link 130 and may have a shape of being concavely recessed upward from the lower side of the hinge link 130.

The link support portion 115 may be inserted into the support groove 134 in a vertical direction which is the Z direction to be engaged with the support groove 134.

As the link support portion 115 and the support groove 134 are engaged with each other, the hinge link 130 may be supported by the main body bracket 110, and may be restricted from moving in the X direction or Z direction.

As an example, the hinge link 130 may be composed of a metal material. However, the material of the hinge link 130 is not limited thereto.

The hinge link 130 described above is only an example of one configuration in which the hinge assembly of the cooking apparatus according to the present disclosure connects the main body bracket and the door bracket, and the present disclosure is not limited thereto.

The hinge assembly 100 may also include an elastic system configured to enable an efficient rotational movement of the door 30 when the door 30 opens or closes the cooking chamber 20.

As an example, the elastic system of the hinge assembly 100 may include a first elastic member 150.

The first elastic member 150 may be configured to accumulate an elastic force when the door 30 opens the cooking chamber 20 and provide the elastic force when the door 30 closes the cooking chamber 20 to prevent the door 30 from being easily closed due to an own weight of the door 30.

In detail, the first elastic member 150 may include a first elastic spring 151 configured to accumulate or provide an elastic force, and a first spring rod 152 configured to be supported on the door bracket 120. The first elastic spring 151 may be disposed to surround an outer circumferential surface of the first spring rod 152.

The first elastic member 150 may be supported by the door bracket 120. The first elastic member 150 may be accommodated on an inner side of the door bracket 120.

As an example, the elastic system of the hinge assembly 100 may also include a second elastic member 160.

The second elastic member 160 may be configured to provide an elastic force in a direction in which the door 30 is opened in an initial stage of a motion in which the door 30 opens the cooking chamber 20 from a closed position so that the door 30 may be easily opened. The second elastic member 160 may also function as a damper preventing the door 30 from being closed too quickly in a motion of closing the cooking chamber 20.

In detail, the second elastic member 160 may include a second elastic spring 161 configured to accumulate or provide an elastic force, a second spring rod 162 configured to be supported on the door bracket 120, and a roller 163 in contact with the hinge link 130.

The second elastic spring 161 may be disposed to surround an outer circumferential surface of the second spring rod 162.

The roller 163 may be coupled to the second spring rod 162. The roller 163 may be configured to be in contact with an outer surface of the hinge link 130 and be movable on the outer surface of the hinge link 130 according to the rotational movement of the door 30. That is, a structure of being in contact with the roller 163 and the hinge link 130 may be configured as a cam structure. A degree of the elastic force accumulated in the second elastic spring 161 may vary depending on a movement of the roller 163.

As an example, the roller 163 may be in contact with an upper side of the hinge link 130.

The second elastic member 160 may be supported by the door bracket 120. The second elastic member 160 may be accommodated on the inner side of the door bracket 120.

However, unlike what is described above, the hinge assembly 100 may not include an elastic system such as the first elastic member 150 and the second elastic member 160, and may include an elastic system of a modified structure to perform a function similar to the above.

With the above configuration, the hinge assembly 100 may connect the door 30 and the main body 10 and rotatably support the door 30.

Components of the hinge assembly 100 may become separated from each other or may deviate from designed positions of the components due to vibration occurring in a process of transporting a completed product, vibration occurring in a process of opening and closing a door of the product, or vibration caused by other external impacts.

Therefore, the hinge assembly 100 of the cooking apparatus 1 according to an embodiment of the present disclosure may need a structure capable of stably coupling the door bracket 120 and the hinge link 130 to the main body bracket 110, stably supporting the door 30, and stably assembling the door 30 to the main body 10.

The hinge assembly 100 may include the locking member 140 configured to fix the door bracket 120 in a position when the door 30 closes the cooking chamber 20. The locking member 140 may be configured to prevent the door bracket 120 and the hinge link 130 from being separated from the main body bracket 110.

Hereinafter, a structure and function of the locking member 140 will be described in detail.

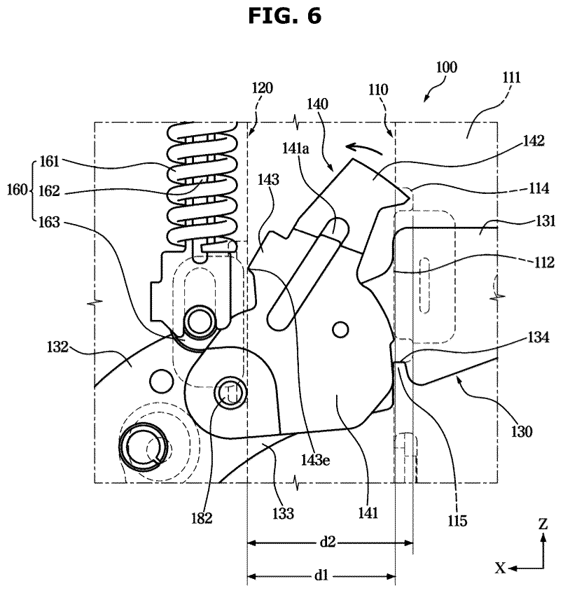

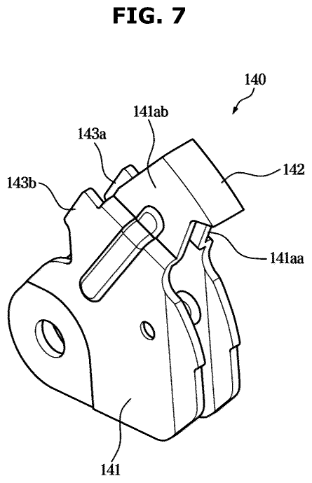

FIG. 5 is an enlarged view of a portion of FIG. 4. FIG. 6 is a view illustrating that a locking member is moved in the hinge assembly of FIG. 5. FIG. 7 is a view illustrating the locking member included in the hinge assembly of the cooking apparatus according to an embodiment of the present disclosure.

Referring to FIGS. 5 to 7, the locking member 140 may be coupled to the hinge link 130. The locking member 140 may be maintained in a fixed position relative to the hinge link 130 regardless of the rotational movement of the door 30. Additionally, as the hinge link 130 is fixed to the main body bracket 110, the locking member 140 may be maintained in a fixed position relative to the main body bracket 110 regardless of the rotational movement of the door 30.

The locking member 140 may be coupled to the hinge link 130 by a coupling shaft 182. The coupling shaft 182 may penetrate the locking member 140 and the hinge link 130. For example, the coupling shaft 182 may extend in the Y direction and penetrate the locking member 140 and the hinge link 130 in the Y direction.

The locking member 140 may include a locking body 141. The locking body 141 may be coupled to the hinge link 130.

The locking body 141 may cover at least a portion of the hinge link 130. For example, the locking body 141 may cover at least a portion of the hinge link 130 on the left and right sides in the Y direction.

As an example, as illustrated, a portion of the locking body 141 may be covered by the door bracket 120 when the door 30 is in the position of closing the cooking chamber 20. In this case, a portion of the locking body 141 may cover the door coupling portion 132 of the hinge link 130.

The coupling shaft 182 may be provided on the locking body 141. The coupling shaft 182 may penetrate the locking body 141 and the hinge link 130 to couple the locking member 140 and the hinge link 130.

As an example, the coupling shaft 182 may be covered by the door bracket 120 when the door 30 is in the position of closing the cooking chamber 20. The coupling shaft 182 may penetrate the door coupling portion 132 of the hinge link 130.

The locking member 140 may be configured to be rotatable relative to the hinge link 130 about the coupling shaft 182.

Although the locking member 140 may be maintained in the fixed position relative to the hinge link 130 regardless of the rotational movement of the door 30, the locking member 140 may be configured to be rotatable relative to the hinge link 130 about the coupling shaft 182.

For example, in a process of manufacturing the hinge assembly 100 or mounting the hinge assembly 100 to the main body 10 and the door 30, a structure in which the locking member 140 is rotatable relative to the hinge link 130 may be required for convenience of manufacturing.

In a state in which the process of manufacturing the hinge assembly 100 or the process of mounting the hinge assembly 100 to the main body 10 and the door 30 is completed, the locking member 140 may be supported by the main body bracket 110 as illustrated in FIG. 5.

Taking a locking member 1140 of a hinge assembly 1100 according to the embodiment illustrated in FIGS. 17 to 19 as an example, the locking member 1140 may be efficiently supported in the X direction by a main body bracket 1110 of the hinge assembly 1100, but may not be efficiently supported in the Z direction or in a direction in which the locking member 1140 rotates relative to a hinge link 1130.

As described above, because the locking member 140 is not completely fixed to the hinge link 130, when the locking member 140 moves relative to the hinge link 130 due to vibration occurring in the process of transporting the completed product, vibration occurring in the process of opening and closing the door of the product, or vibration caused by other external impacts, the locking member 140 may deviate from a position of being supported on the main body bracket 110.

In particular, a problem may occur when there is a difference between a height of the coupling shaft 182 in the Z direction by which the locking member 140 and the hinge link 130 are coupled and a height of a point in the Z direction at which the locking member 140 is supported on the main body bracket 110.

In the embodiment illustrated in FIGS. 5 to 7, the locking member 140 may be engaged with and coupled to the main body bracket 110. In this case, the locking member 140 may be supported not only in the X direction but also in the Z direction relative to the main body bracket 110, and in a rotational direction of the locking member 140 relative to the hinge link 130. Accordingly, the locking member 140 may be more stably supported on the main body bracket 110 and may more stably fix the door bracket 120 in the position when the door 30 closes the cooking chamber 20.

The locking member 140 may be lock-coupled to the main body bracket 110 to be maintained in the fixed position relative to the main body bracket 110. That is, the locking member 140 may be maintained in a certain position regardless of the rotational movement of the door 30.

In detail, the locking member 140 may include an engaging portion 142 to be engaged with and coupled to the main body bracket 110. As the engaging portion 142 is engaged with and coupled to the main body bracket 110, the door bracket 120 and the hinge link 130 may be prevented from being separated from the main body bracket 110, and the door bracket 120 may be fixed in the position when the door 30 closes the cooking chamber 20.

The main body bracket 110 may include an insertion portion 114 into which at least a portion of the engaging portion 142 is inserted. The engaging portion 142 may be engaged with and coupled to the main body bracket 110.

The engaging portion 142 may protrude from the locking body 141 toward an inner side of the insertion portion 114 so that at least a portion of the engaging portion 142 may be engaged with and coupled to the insertion portion 114 by insertion.

As the engaging portion 142 is inserted into the insertion portion 114, the locking member 140 may be firmly fixed to the main body bracket 110, and the door bracket 120 may be efficiently fixed in the position relative to the main body bracket 110.

The insertion portion 114 may be provided at one end of the main body bracket 110 adjacent to the door bracket 120. The insert portion 114 may be formed to have a shape of being recessed concavely in a direction opposite to the door bracket 120 (rearward in the X direction based on the drawings) from one end of the cover portion 111 adjacent to the door bracket 120.

The insertion portion 114 may be formed to communicate with the accommodation space 116 (see FIG. 11) inside the main body bracket 110. That is, the inside of the main body bracket 110 may be formed as an integrated space in which the insertion portion 114 and the accommodation space 116 are not partitioned from each other. However, the present disclosure is not limited thereto, and an internal space of the main body bracket 110 may be formed such that the insertion portion 114 and the accommodation space 116 are partitioned from each other.

As described above, because the locking member 140 is not completely fixed to the hinge link 130, there is a possibility that the engaging portion 142 of the locking member 140 may deviate from the main body bracket 110 (for example, in a case where the locking member 140 rotates in the direction illustrated in FIG. 6) due to vibration occurring in the process of transporting the completed product, vibration occurring in the process of opening and closing the door of the product, or vibration caused by other external impacts.

In order to prevent this possibility, the locking member 140 may include a deviation prevention portion 143. The deviation prevention portion 143 may be provided to prevent the engaging portion 142 from deviating from the main body bracket 110.

Specifically, the deviation prevention portion 143 may be provided to interfere with the door bracket 120 to prevent the engaging portion 142 from deviating from the main body bracket 110.

When the door 30 is in the position of closing the cooking chamber 20, the deviation prevention portion 143 may be disposed between the door bracket 120 and the engaging portion 142.

When the door 30 closes the cooking chamber 20, a distance d1 between the door bracket 120 and the main body bracket 110 may be set to be shorter than a distance d2 between one end of the engaging portion 142 in a direction of being inserted into the insertion portion 114 and one end of the deviation prevention portion 143 interfering with the door bracket 120. Herein, the distance d1 between the door bracket 120 and the main body bracket 110 refers to a distance measured in the X direction between a portion of the door bracket 120 that may interfere with the deviation prevention portion 143 and a portion of the cover portion 111 adjacent to the insertion portion 114. Also, the distance d2 between one end of the engaging portion 142 in the direction of being inserted into the insertion portion 114 and one end of the deviation prevention portion 143 interfering with the door bracket 120 refers to a distance measured in the X direction between one end of the engaging portion 142 in the direction of being inserted into the insertion portion 114 and one end of the deviation prevention portion 143 interfering with the door bracket 120.

The locking member 140 may be configured to be positioned between a first position (see FIG. 5) in which the engaging portion 142 is maximally inserted into the insertion portion 114 and a second position (see FIG. 6) in which the engaging portion 142 moves in a direction of deviating from the insertion portion 114 at the first position. The first and second positions of the locking member 140 may be defined as relative positions of the main body bracket 110 and the hinge link 130.

As an example, the locking member 140 may be configured to be rotatable between the first position and the second position centered on the coupling shaft 182. When the locking member 140 moves between the first position and the second position, the engaging portion 142 may move substantially along an arc centered on the coupling shaft 182.

The deviation prevention portion 143 may be provided to come into contact with the door bracket 120 when the door 30 closes the cooking chamber 20 and the locking member 140 is in the second position. That is, the deviation prevention portion 143 may be provided to interfere with the door bracket 120 when the locking member 140 reaches the second position.

Conversely, the deviation prevention portion 143 may be disposed to be spaced apart from the door bracket 120 when the locking member 140 is in the first position. A reason of this arrangement is because in a case in which the deviation prevention portion 143 always interferes with the door bracket 120 when the door 30 is closed, a collision may occur between the door bracket 120 and the deviation prevention portion 143 whenever the door 30 rotates from a position of opening the cooking chamber 20 to the position of closing the cooking chamber 20, which may cause noise and vibration and damage to components.

With this configuration, even if the engaging portion 142 moves in the direction of deviating from the insertion portion 114, the deviation prevention portion 143 may interfere with the door bracket 120 before the engaging portion 142 completely deviates from the insertion portion 114.

The deviation prevention portion 143 may be formed to protrude from the locking body 141 so that the locking member 140 may interfere with the door bracket 120 even when rotating only a small angle about the coupling shaft 182. As an example, the deviation prevention portion 143 may protrude from the locking body 141 in a direction opposite to the main body bracket 110.

A distance from the coupling shaft 182 to the deviation prevention portion 143 may be set to be shorter than a distance from the coupling shaft 182 to the engaging portion 142. In this case, even if a length at which the deviation prevention portion 143 protrudes from the locking body 141 is not designed to be excessively long, the deviation prevention portion 143 may interfere with the door bracket 120 by moving only a short distance. Also, even if a length at which the engaging portion 142 protrudes from the locking body 141 is not designed to be excessively long, the engaging portion 142 may be efficiently prevented from deviating from the insertion portion 114.

The deviation prevention portion 143 may extend in a direction away from the door bracket 120 from a tip 143e coming into contact with the door bracket 120 at the second position when the door 30 closes the cooking chamber 20. When the tip 143e of the deviation prevention portion 143 comes into contact with the door bracket 120, the tip 143e and the door bracket 120 may come into contact to approximate a line contact.

With this configuration, not only unnecessary interference between the deviation prevention portion 143 and the door bracket 120 may be prevented, but also a load applied to the deviation prevention portion 143 may be distributed.

In this case, as a length at which the tip 143e of the deviation prevention portion 143 protrudes from the locking body 141 toward the door bracket 120 increases, a distance between the first and second positions of the locking member 140 may become shorter.

The tip 143e of the deviation prevention portion 143 may be provided on a side adjacent to the coupling shaft 182 of the deviation prevention portion 143. In this case, even if the locking member 140 rotates only by a small angle about the coupling shaft 182, the engaging portion 142 may be prevented from deviating from the insertion portion 114.

The locking member 140 may include an extension portion 141a extending from the deviation preventing portion 143 to the engaging portion 142. The extension portion 141a may be a portion of the locking body 141.

As illustrated in FIG. 7, the deviation prevention portion 143 of the locking member 140 may include a plurality of deviation prevention portions 143a and 143b disposed to be spaced apart from each other.

When the locking member 140 is in the second position and the door 30 is in the position of closing the cooking chamber 20, the plurality of deviation prevention portions 143a and 143b may each interfere with the door bracket 120.

As an example, the plurality of deviation prevention portions 143a and 143b may be disposed to be spaced apart from each other in the Y direction.

As an example, the plurality of deviation prevention portions 143a and 143b may be formed to have shapes or sizes corresponding to each other.

The locking member 140 may include a plurality of extension portions 141aa and 141ab extending from the plurality of deviation prevention portions 143a and 143b to the engaging portion 142, respectively.

Each of the plurality of extension portions 141aa and 141ab may be a portion of the locking body 141.

The plurality of extension portions 141aa and 141ab may be disposed to be spaced apart from each other. As an example, the plurality of extension portions 141aa and 141ab may be disposed to be spaced apart from each other in the Y direction.

As an example, the plurality of extension portions 141aa and 141ab may be formed to have shapes or sizes corresponding to each other.

The engaging portion 142 may connect the plurality of extension portions 141aa and 141ab to each other. As an example, the plurality of extension portions 141aa and 141ab may be connected to opposite ends of the engaging portion 142 in the Y direction, respectively.

As illustrated in FIG. 7, the engaging portion 142, the deviation prevention portion 143, and the extension portion 141a of the locking member 140 may be formed integrally. For example, the locking member 140 may be formed such that the opposite ends to which the plurality of extension portions 141aa and 141ab of the engaging portion 142 are respectively connected are bent.

Furthermore, the locking member 140 may be formed as an entire body.

As an example, the locking member 140 may be composed of a metal material. However, the material of locking member 140 is not limited thereto.

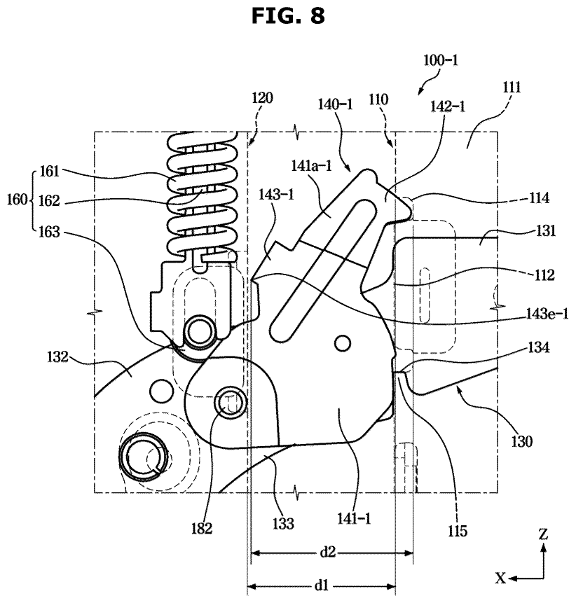

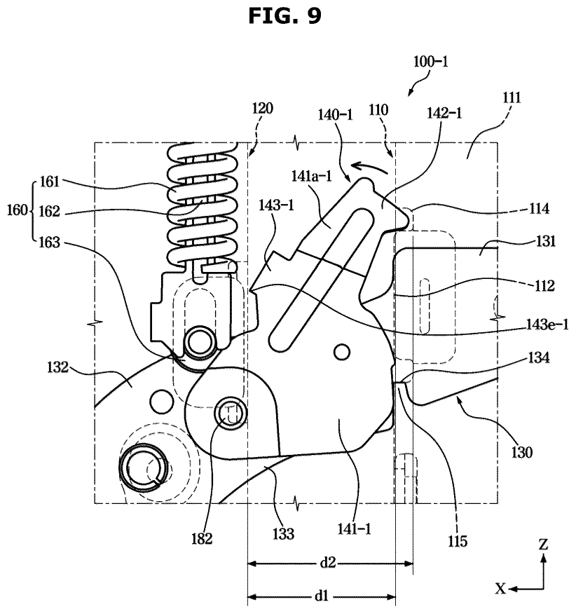

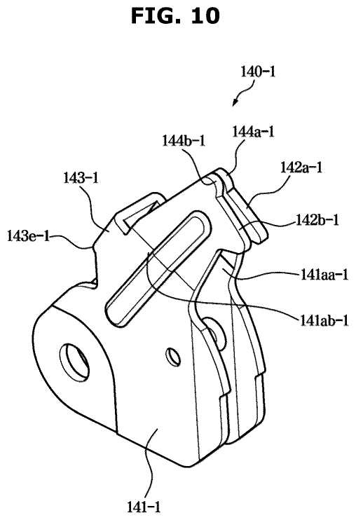

FIG. 8 is an enlarged view of some components of a hinge assembly of the cooking apparatus according to an embodiment of the present disclosure. FIG. 9 is a view illustrating that a locking member is moved in the hinge assembly of FIG. 8. FIG. 10 is a view illustrating the locking member included in the hinge assembly of the cooking apparatus according to an embodiment of the present disclosure.

Components of the embodiment illustrated in FIGS. 8 to 10 that are the same as those of the embodiment illustrated in FIGS. 1 to 7 may be given the same reference numerals, and descriptions thereof may be omitted.

Referring to FIGS. 8 to 10, the cooking apparatus 1 according to an embodiment of the present disclosure may include a hinge assembly 100-1 configured to connect the door 30 and the main body 10. The hinge assembly 100-1 may support the door 30 such that the door 30 is rotatable relative to the main body 10.

The hinge assembly 100-1 may include the main body bracket 110 configured to be coupled to the main body 10, the door bracket 120 configured to be coupled to the door 30, and the hinge link 130 configured to connect the main body bracket 110 and the door bracket 120.

The main body bracket 110, the door bracket 120, and the hinge link 130 included in the hinge assembly 100-1 may have the same configuration as the main body bracket 110, the door bracket 120, and the hinge link 130 included in the hinge assembly 100 in the embodiment described with reference to FIGS. 1 to 7, and detailed descriptions thereof will be omitted.

The hinge assembly 100-1 may include the locking member 140 configured to fix the door bracket 120 in the position when the door 30 closes the cooking chamber 20. The locking member 140-1 may have a configuration corresponding to that of the locking member 140 included in the hinge assembly 100 in the embodiment described with reference to FIGS. 1 to 7, and may provide a function corresponding thereto.

For example, the locking member 140-1 may be coupled to the hinge link 130. The locking member 140-1 may include a locking body 141-1 coupled to the hinge link 130, and the locking body 141-1 may be coupled to the hinge link 130 by the coupling shaft 182. The locking member 140-1 may be configured to be rotatable about the coupling shaft 182.

For example, the locking member 140-1 may include an engaging portion 142-1 engaged with and coupled to the main body bracket 110. The engaging portion 142-1 may be inserted into the insertion portion 114 of the main body bracket 110. The engaging portion 142-1 may protrude from the locking body 141-1.

For example, the locking member 140-1 may include a deviation prevention portion 143-1 provided to prevent the engaging portion 142-1 from deviating from the main body bracket 110. The deviation prevention portion 143-1 may be provided to interfere with the door bracket 120 to prevent the engaging portion 142-1 from deviating from the insertion portion 114 when the door 30 is in the position of closing the cooking chamber 20. The deviation prevention portion 143-1 may protrude from the locking body 141-1.

The deviation prevention portion 143-1 may extend in the direction away from the door bracket 120 from a tip 143e-1 coming into contact with the door bracket 120 at the second position when the door 30 closes the cooking chamber 20. When the tip 143e-1 of the deviation prevention portion 143-1 comes into contact with the door bracket 120, the tip 143e-1 and the door bracket 120 may come into contact to approximate a line contact.

The tip 143e-1 of the deviation prevention portion 143-1 may be provided on a side adjacent to the coupling shaft 182 of the deviation prevention portion 143-1.

The locking member 140-1 may include an extension portion 141a-1 extending from the engaging portion 142-1 toward the deviation preventing portion 143-1. The extension portion 141a-1 may be a portion of the locking body 141-1.

As illustrated in FIG. 10, the engaging portion 142-1 of the locking member 140-1 may include a plurality of engaging portions 142a-1 and 142b-1 separated from each other.

The plurality of engaging portions 142a-1 and 142b-1 may each be engaged with and coupled to the main body bracket 110. In detail, the plurality of engaging portions 142a-1 and 142b-1 may be each inserted into the insertion portion 114. In this case, the plurality of engaging portions 142a-1 and 142b-1 may be simultaneously inserted into the one insertion portion 114, but is not limited thereto.

As an example, the plurality of engaging portions 142a-1 and 142b-1 may face each other in the Y direction.

As an example, the plurality of engaging portions 142a-1 and 142b-1 may be formed to have shapes or sizes corresponding to each other.

The locking member 140-1 may include a plurality of extension portions 141aa-1 and 141ab-1 extending from the plurality of engaging portions 142a-1 and 142b-1, respectively, toward the deviation prevention portion 143-1.

The deviation prevention portion 143-1 may connect the plurality of extension portions 141aa-1 and 141ab-1 to each other.

As illustrated in FIG. 10, the engaging portion 142-1, the deviation prevention portion 143-1, and the extension portion 141a-1 of the locking member 140-1 may be formed integrally. For example, the locking member 140-1 may be formed such that opposite ends of the deviation prevention portion 143-1 are respectively are bent by the Y direction.

Furthermore, the locking member 140-1 may be formed as an entire body.

As an example, the locking member 140-1 may be composed of a metal material. However, the material of locking member 140-1 is not limited thereto.

The locking member 140-1 may include a pair of contact protrusions 144a-1 and 144b-1 in contact with each other.

A pair of the contact protrusions 144a-1 and 144b-1 may protrude from a pair of the engaging portions 142, respectively. For example, the pair of contact protrusions 144a-1 and 144b-1 may protrude from the pair of engaging portions 142 in a direction in which a pair of the extension portions 141aa-1 and 141ab-1 extend, respectively.

In a process of manufacturing the locking member 140-1 by bending opposite ends of the deviation prevention portion 143-1 in the Y direction, the opposite ends of the deviation prevention portion 143-1 in the Y direction may be bent until the pair of contact protrusions 144a-1 and 144b-1 come into contact with each other.

As such, as the locking member 140-1 includes the pair of contact protrusions 144a-1 and 144b-1, manufacturing efficiency of the locking member 140-1 including the pair of engaging portions 142 may be improved.

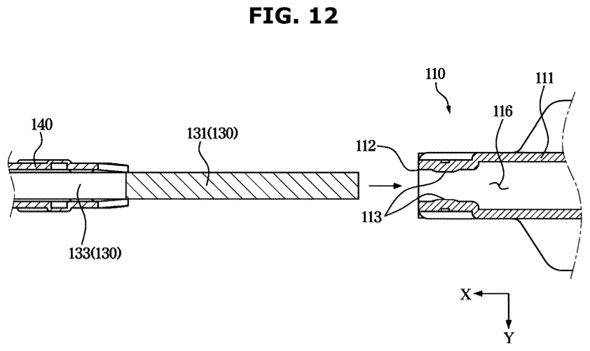

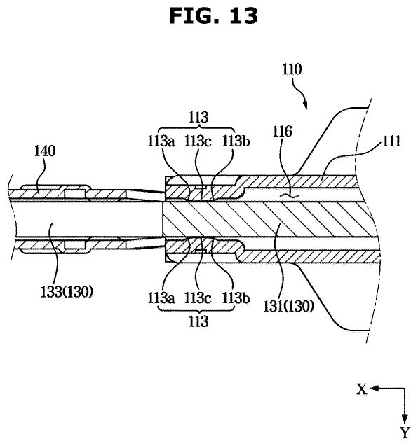

FIG. 11 is a view illustrating that some components of a hinge assembly of a cooking apparatus according to an embodiment of the present disclosure are exploded. FIG. 12 is a view illustrating a process of manufacturing the hinge assembly of the cooking apparatus according to an embodiment of the present disclosure. FIG. 13 is a view illustrating a process of manufacturing the hinge assembly of the cooking apparatus according to an embodiment of the present disclosure.

Components of the embodiment illustrated in FIGS. 11 to 13 that are the same as those of the embodiment illustrated in FIGS. 1 to 7 may be given the same reference numerals, and descriptions thereof may be omitted.

As illustrated in FIG. 1, the door 30 and the control panel 41 of the cooking apparatus 1 according to an embodiment of the present disclosure may form at least a portion of a front appearance of the cooking apparatus 1. When looking at cooking apparatus 1 with the cooking chamber 20 closed from the front, the user may perceive the front surface of the door 30 and a front surface of the control panel 41 as a main appearance of the cooking apparatus 1.

In order to improve the external quality of the product, the door 30 and the control panel 41 of the cooking apparatus 1 may be required to be arranged parallel to each other in the vertical direction.

For example, as illustrated in FIG. 1, it may be assumed that door 30 and control panel 41 are arranged in the vertical direction which is in the Z direction, and a width of the door 30 in the Y direction and a width of the control panel 41 in the Y direction are almost the same. In this case, when a left surface 41a of the control panel 41 and a left surface 30a of the door 30 are arranged parallel to each other in the vertical direction, and a right surface 41b of the control panel 41 and a right surface 30b of the door 30 are arranged parallel to each other in the vertical direction, the external quality may be improved when the cooking apparatus 1 is viewed from the front.

Referring to FIGS. 11 to 13, in the hinge assembly 100 of the cooking apparatus 1 according to an embodiment of the present disclosure, at least a portion of the hinge link 130 may be accommodated in the main body bracket 110. In detail, the main body coupling portion 131 of the hinge link 130 may be accommodated in the accommodation space 116 inside the main body bracket 110.

As an example, as illustrated in FIG. 11, a method of manufacturing the hinge assembly 100 of the cooking apparatus 1 according to an embodiment of the present disclosure may include a process of inserting the main body coupling portion 131 of the hinge link 130 into the accommodation space 116 through the coupling hole 112 of the main body bracket 110 to couple the hinge link 130 and the main body bracket 110. In this case, a direction in which the main body coupling portion 131 is inserted into the accommodation space 116 by penetrating the coupling hole 112 may be substantially parallel to a front-rear direction which is the X direction with respect to the cooking apparatus 1.

It may be assumed that a width (e.g., width in the Y direction) of the accommodation space 116 of the main body bracket 110 is wider than a width (in the same direction as the width of the accommodation space 116 mentioned above, e.g., width in the Y direction) of the main body coupling portion 131 accommodated in the accommodation space 116. In this case, the hinge link 130 may not be fixed in a width direction of the accommodation space 116 relative to the main body bracket 110, and the hinge link 130 may be movable in the width direction of the accommodation space 116 relative to the main body bracket 110. In this case, the main body bracket 110 may be maintained in the fixed position relative to the main body 10, and the hinge link 130 may be maintained in a fixed position relative to the door bracket 120, so that a relative position of the door 30 to the main body 10 may be movable.

Because of this, for example, when the door 30 moves in the Y direction from a designed position of the door 30, the door 30 and the control panel 41 are not arranged side by side, which may deteriorate the external quality of the product.

In order to solve this problem, the main body bracket 110 may include a protrusion portion 113 provided to prevent the hinge link 130 from moving. The protrusion portion 113 may be formed to protrude toward at least a portion of the hinge link 130 accommodated in the main body bracket 110. In other words, the protrusion portion 113 may protrude toward the main body coupling portion 131 accommodated in the accommodation space 116 of the main body bracket 110.

The protrusion portion 113 may be provided on an inner side of the main body bracket 110. The protrusion portion 113 may protrude from the cover portion 111. The protrusion portion 113 may protrude from the cover portion 111 in an inner direction of the accommodation space 116. The protrusion portion 113 may protrude from the cover portion 111 toward at least a portion of the hinge link 130 (that is, the main body coupling portion 131) accommodated in the accommodation space 116.

The protrusion portion 113 may support the hinge link 130. In detail, the protrusion portion 113 may support the hinge link 130 by being in contact with the main body coupling portion 131 of the hinge link 130 so that the hinge link 130 does not move relative to the main body bracket 110. That is, the protrusion portion 113 may restrict a movement of the hinge link 130 so that the hinge link 130 does not move relative to the main body bracket 110.

Because the protrusion portion 113 is provided to restrict the movement of the hinge link 130 after the hinge link 130 is coupled to the main body bracket 110, the protrusion portion 113 may restrict the hinge link 130 from moving in a direction different from a direction in which the main body coupling portion 131 is inserted into the main body bracket 110 in a process of coupling the hinge link 130 and the main body bracket 110.

When the door bracket 120 and the main body bracket 110 are arranged to face each other in a first direction, the protrusion portion 113 may be provided to prevent the hinge link 130 from moving in a second direction different from the first direction. The protrusion portion 113 may protrude from the cover portion 111 in a direction parallel to the second direction and may support the hinge link 130 in the direction parallel to the second direction.

Herein, the first direction may be parallel to the direction in which the main body coupling portion 131 is inserted into the main body bracket 110 in the process of coupling the hinge link 130 and the main body bracket 110. The first direction may also be parallel to a direction in which the main body 10 and the door 30 face each other. The first direction may also be parallel to the front-rear direction of the cooking apparatus 1.

Herein, the second direction may be parallel to a direction in which the pair of side plates of the cover portion 111 face each other. The second direction may also be parallel to a direction in which the plurality of hinge assemblies 100a and 100b (see FIG. 2) is arranged. The second direction may also be parallel to a direction of the rotation shaft of the door 30. The second direction may also be parallel to a left-right direction of the cooking apparatus 1.

More specifically, the first direction and the second direction may be orthogonal to each other. For example, based on the drawings, the first direction may be the X direction (the front-rear direction of the cooking apparatus 1), and the second direction may be the Y direction (the left-right direction of the cooking apparatus 1). As illustrated in FIGS. 11 to 13, the protrusion portion 113 may restrict the movement of the hinge link 130 in the Y direction.

However, the second direction in which the protrusion portion 113 restricts the movement of the hinge link 130 is not limited to that described above, and may vary depending on a shape or size of the inside of the main body bracket 110 or a shape or size of the main body coupling portion 131 of the hinge link 130.

Hereinafter, for convenience of explanation, an embodiment will be described as an example in which the first direction is parallel to the front-rear direction of the cooking apparatus 1 and the second direction is parallel to the left-right direction of the cooking apparatus 1.

As an example, the protrusion portion 113 may include a pair of the protrusion portions 113 arranged to face each other. A distance between the pair of protrusion portions 113 may correspond to a thickness of at least a portion of the hinge link 130 accommodated in the main body bracket 110, that is, a thickness of the main body coupling portion 131.

As an example, the pair of protrusion portions 113 may be arranged in the Y direction of the cooking apparatus 1. That is, the pair of protrusion portions 113 may be arranged in a left-right direction of the main body 10. The pair of protrusion portions 113 may be arranged to face each other in the Y direction.

In this case, one protrusion portion of the pair of protrusion portions 113 may be in contact with a left side of the hinge link 130, and the other protrusion portion of the pair of protrusion portions 113 may be in contact with a right side of the hinge link 130.

However, the number of the protrusion portions 113 provided on the main body bracket 110 is not limited thereto, and for example, the main body bracket 110 may be provided with only a single protrusion portion, or may be provided with three or more protrusion portions.

With the above configuration, the main body bracket 110 of the hinge assembly 100 may prevent the hinge link 130 from moving relative to the main body bracket 110 by including the protrusion portion 113.

However, in a case in which the internal space of the main body bracket 110 is formed narrow from a portion adjacent to the coupling hole 112 to correspond to the thickness of the main body coupling portion 131, or the internal space of the main body bracket 110 is formed as a whole to correspond to the thickness of the main body coupling portion 131, in the process of coupling the hinge link 130 and the main body bracket 110, it may not be easy to insert the main body coupling portion 131 into the main body bracket 110.

Therefore, it may be appropriate for the accommodation space 116 inside the main body bracket 110 to be formed to have a width wider than the thickness of the main body coupling portion 131 in a portion near the coupling hole 112 into which the main body coupling portion 131 begins to be inserted, and have a width narrowed by the protrusion portion 113 (i.e., a width corresponding to the thickness of the main body coupling portion 131) at a rear portion in the X direction from the coupling hole 112.

In other words, the protrusion portion 113 may be disposed to be spaced apart from one end of the cover portion 111 on the door bracket 120 side (that is, one end of the cover portion 111 on which the coupling hole 112 is formed). In detail, the protrusion portion 113 may be disposed further rearward in the X direction than the one end of the cover portion 111 on the door bracket 120 side. The protrusion portion 113 may be disposed further rearward in the X direction than the coupling hole 112.

The one end of the cover portion 111 on the door bracket 120 side may be disposed to be spaced apart from the hinge link 130. Also, at least a portion of the cover portion 111 positioned between the one end of the cover portion 111 on the door bracket 120 side and the protrusion portion 113 may be spaced apart from the hinge link 130. With this configuration, the main body coupling portion 131 may be easily inserted into the main body bracket 110 in the process of coupling the hinge link 130 and the main body bracket 110.

The protrusion portion 113 may include a first inclined surface 113a. The first inclined surface 113a may be provided on the inner side of the main body bracket 110.

The first inclined surface 113a may extend to become close to the hinge link 130 as the first inclined surface becomes away from the door bracket 120. The first inclined surface 113a may extend such that a length thereof protruding from the cover portion 111 becomes long and to become close to the main body coupling portion 131 of the hinge link 130, as the first inclined surface becomes away from the door bracket 120. The first inclined surface 113a may extend to protrude toward an inner side of the accommodation space 116 in the Y direction as the first inclined surface faces rearward in the X direction. The first inclined surface 113a may extend to be inclined in the front-rear direction of the cooking apparatus 1.

The first inclined surface 113a may guide a movement of the main body coupling portion 131 so that the main body coupling portion 131 may be easily inserted into the main body bracket 110 in the process of coupling the hinge link 130 and the main body bracket 110.

The protrusion portion 113 may include a second inclined surface 113b extending in a different direction from the first inclined surface 113a. The second inclined surface 113b may be provided on the inner side of the main body bracket 110.

The second inclined surface 113b may extend to become away from the hinge link 130 as the second inclined surface becomes away from the door bracket 120. The second inclined surface 113b may extend such that a length thereof protruding from the cover portion 111 becomes short and to become away from the main body coupling portion 131 of the hinge link 130, as the second inclined surface becomes away from the door bracket 120. The second inclined surface 113b may extend such that a degree to which the second inclined surface protrudes inwardly from the accommodation space 116 in the Y direction becomes short as the second inclined surface faces rearward in the X direction. The second inclined surface 113b may extend to be inclined in the front-rear direction of the cooking apparatus 1.

The protrusion portion 113 may include a contact surface 113c provided to come into contact with the hinge link 130. The contact surface 113c may be provided on the inner side of the main body bracket 110 to come into contact with the main body coupling portion 131.

The contact surface 113c may be provided between the first inclined surface 113a and the second inclined surface 113b. The contact surface 113c may support the hinge link 130 and restrict the movement of the hinge link 130. The contact surface 113c may distribute a load that the protrusion portion 113 receives from the hinge link 130.

The contact surface 113c may extend in a direction substantially parallel to the X direction, or extend such that an angle at which an extension direction of the contact surface 113c is inclined with respect to the X direction is at least smaller than angles at which the first inclined surface 113a and the second inclined surface 113b are inclined with respect to the X direction, respectively.

As an example, the protrusion portion 113 may be formed to have an entirely convex curved shape. As illustrated in FIGS. 11 to 13, the first inclined surface 113a, the second inclined surface 113b, and the contact surface 113c may each be formed in a convex curved shape toward the hinge link 130. In this case, the contact surface 113c may more efficiently distribute the load that the protrusion portion 113 receives from the hinge link 130.

As an example, the protrusion portion 113 may be formed such that a length thereof in the Z direction is longer than a length thereof in the X direction. However, the protrusion portion 113 is not limited thereto and may have various lengths depending on directions.

As an example, the protrusion portion 113 may be formed integrally with the cover portion 111.

As an example, the protrusion portion 113 may be manufactured using press processing in which a sheet material used as a raw material for the cover portion 111 is pressed into a mold.

However, the protrusion portion 113 is not limited thereto, and may be manufactured using various manufacturing methods and may be formed as a component distinct from the cover portion 111.

FIGS. 11 to 13 illustrate the hinge assembly 100 that is identical to the hinge assembly 100 of the embodiment illustrated in FIGS. 3 to 7, but is not limited thereto, and the configuration (protrusion portion 113, etc.) of the hinge assembly 100 described with reference to FIGS. 11 to 13 may be equally applied to the hinge assembly 100-1 of the embodiment described with reference to FIGS. 8 to 10.

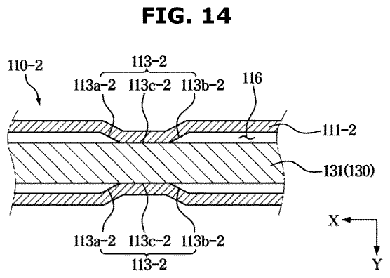

FIG. 14 is an enlarged cross-sectional view illustrating that the hinge assembly of the cooking apparatus according to an embodiment of the present disclosure is cut in a transverse direction and enlarged.

Components of the embodiment illustrated in FIG. 14 that are the same as those of the embodiments illustrated in FIGS. 1 to 13 may be given the same reference numerals, and descriptions thereof may be omitted.

Referring to FIG. 14, in the hinge assembly 100 of the cooking apparatus 1 according to an embodiment of the present disclosure, at least a portion of the hinge link 130 may be accommodated inside a main body bracket 110-2. In detail, the main body coupling portion 131 of the hinge link 130 may be accommodated in the accommodation space 116 inside the main body bracket 110-2.

The main body bracket 110-2 may include a protrusion portion 113-2 provided to prevent the hinge link 130 from moving. The protrusion portion 113-2 may be formed to protrude toward the at least a portion of the hinge link 130 accommodated in the main body bracket 110-2. In other words, the protrusion portion 113-2 may protrude toward the main body coupling portion 131 accommodated in the accommodation space 116 of the main body bracket 110-2.

The protrusion portion 113-2 may be provided on an inner side of the main body bracket 110-2. The protrusion portion 113-2 may protrude from a cover portion 111-2. The protrusion portion 113-2 may protrude from the cover portion 111-2 in an inner direction of the accommodation space 116. The protrusion portion 113-2 may protrude from the cover portion 111-2 toward at least a portion (that is, the main body coupling portion 131) of the hinge link 130 accommodated in the accommodation space 116.

The protrusion portion 113-2 may support the hinge link 130. In detail, the protrusion portion 113-2 may support the hinge link 130 by being in contact with the main body coupling portion 131 of the hinge link 130 so that the hinge link 130 does not move relative to the main body bracket 110-2. That is, the protrusion portion 113-2 may restrict the movement of the hinge link 130 so that the hinge link 130 does not move relative to the main body bracket 110-2.

The protrusion portion 113-2 may restrict the hinge link 130 from moving in a direction different from a direction in which the main body coupling portion 131 is inserted into the main body bracket 110-2 in a process of coupling the hinge link 130 and the main body bracket 110-2.

When the door bracket 120 and the main body bracket 110-2 are arranged to face each other in the first direction, the protrusion portion 113-2 may be provided to prevent the hinge link 130 from moving in the second direction different from the first direction. The protrusion portion 113-2 may protrude from the cover portion 111-2 in a direction parallel to the second direction and may support the hinge link 130 in the direction parallel to the second direction.

Herein, the first direction may be parallel to the direction in which the main body coupling portion 131 is inserted into the main body bracket 110-2 in the process of coupling the hinge link 130 and the main body bracket 110-2. The first direction may also be parallel to the direction in which the main body 10 and the door 30 face each other. The first direction may also be parallel to the front-rear direction of the cooking apparatus 1.

Herein, the second direction may be parallel to a direction in which a pair of side plates of the cover portion 111-2 face each other. The second direction may also be parallel to the direction in which the plurality of hinge assemblies 100a and 100b (see FIG. 2) is arranged. The second direction may also be parallel to the direction of the rotation shaft of the door 30. The second direction may also be parallel to the left-right direction of the cooking apparatus 1.

More specifically, the first direction and the second direction may be orthogonal to each other. For example, based on the drawing, the first direction may be the X direction (the front-rear direction of the cooking apparatus 1), and the second direction may be the Y direction (the left-right direction of the cooking apparatus 1). As illustrated in FIG. 14, the protrusion portion 113-2 may restrict the movement of the hinge link 130 in the Y direction.

However, the second direction in which the protrusion portion 113-2 restricts the movement of the hinge link 130 is not limited to that described above, and may vary depending on a shape or size of the inside of the main body bracket 110-2 or the shape or size of the main body coupling portion 131 of the hinge link 130.

Hereinafter, for convenience of explanation, an embodiment will be described as an example in which the first direction is parallel to the front-rear direction of the cooking apparatus 1 and the second direction is parallel to the left-right direction of the cooking apparatus 1.

As an example, the protrusion portion 113-2 may include a pair of the protrusion portions 113-2 arranged to face each other. A distance between the pair of protrusion portions 113-2 may correspond to a thickness of at least a portion of the hinge link 130 accommodated in the main body bracket 110-2, that is, a thickness of the main body coupling portion 131.

As an example, the pair of protrusion portions 113-2 may be arranged in the Y direction of the cooking apparatus 1. That is, the pair of protrusion portions 113-2 may be arranged in the left-right direction of the main body 10. The pair of protrusion portions 113-2 may be arranged to face each other in the Y direction.

In this case, one protrusion portion of the pair of protrusion portions 113-2 may be in contact with the left side of the hinge link 130, and the other protrusion portion of the pair of protrusion portions 113-2 may be in contact with the right side of the hinge link 130.

However, the number of the protrusion portions 113-2 provided on the main body bracket 110-2 is not limited thereto, and for example, the main body bracket 110-2 may be provided with only a single protrusion portion, or may be provided with three or more protrusion portions.

With the above configuration, the main body bracket 110-2 of the hinge assembly 100 may prevent the hinge link 130 from moving relative to the main body bracket 110-2 by including the protrusion portion 113-2.

The protrusion portion 113-2 may be disposed to be spaced apart from one end of the cover portion 111-2 on the door bracket 120 side. In detail, the protrusion portion 113-2 may be disposed further rearward in the X direction than the one end of the cover portion 111-2 on the door bracket 120 side.

The one end of the cover portion 111-2 on the door bracket 120 side may be disposed to be spaced apart from the hinge link 130. Also, at least a portion of the cover portion 111-2 positioned between the one end of the cover portion 111-2 on the door bracket 120 side and the protrusion portion 113-2 may be spaced apart from the hinge link 130. With this configuration, the main body coupling portion 131 may be easily inserted into the main body bracket 110-2 in the process of coupling the hinge link 130 and the main body bracket 110-2.

The protrusion portion 113-2 may include a first inclined surface 113a-2. The first inclined surface 113a-2 may be provided on the inner side of the main body bracket 110-2.

The first inclined surface 113a-2 may extend to become close to the hinge link 130 as the first inclined surface becomes away from the door bracket 120. The first inclined surface 113a-2 may extend such that a length thereof protruding from the cover portion 111-2 becomes long and to become close to the main body coupling portion 131 of the hinge link 130, as the first inclined surface becomes away from the door bracket 120. The first inclined surface 113a-2 may extend to protrude toward the inner side of the accommodation space 116 in the Y direction as the first inclined surface faces rearward in the X direction. The first inclined surface 113a-2 may extend to be inclined in the front-rear direction of the cooking apparatus 1.

The protrusion portion 113-2 may include a second inclined surface 113b-2 extending in a different direction from the first inclined surface 113a-2. The second inclined 113b-2 may be provided on the inner side of the main body bracket 110-2.

The second inclined surface 113b-2 may extend to become away from the hinge link 130 as the second inclined surface becomes away from the door bracket 120. The second inclined surface 113b-2 may extend such that a length thereof protruding from the cover portion 111-2 becomes short and to become away from the main body coupling portion 131 of the hinge link 130, as the second inclined surface becomes away from the door bracket 120. The second inclined surface 113b-2 may extend such that a degree to which the second inclined surface protrudes inwardly from the accommodation space 116 in the Y direction becomes short as the second inclined surface faces rearward in the X direction. The second inclined surface 113b-2 may extend to be inclined in the front-rear direction of the cooking apparatus 1.

The protrusion portion 113-2 may include a contact surface 113c-2 provided to come into contact with the hinge link 130. The contact surface 113c-2 may be provided on the inner side of the main body bracket 110-2 to come into contact with the main body coupling portion 131.

The contact surface 113c-2 may be provided between the first inclined surface 113a and the second inclined surface 113b-2. The contact surface 113c-2 may support the hinge link 130 and restrict the movement of the hinge link 130.

The contact surface 113c-2 may extend in a direction substantially parallel to the X direction, or extend such that an angle at which an extension direction of the contact surface 113c-2 is inclined with respect to the X direction is at least smaller than angles at which the first inclined surface 113a-2 and the second inclined surface 113b-2 are inclined with respect to the X direction, respectively.

As illustrated in FIG. 14, the first inclined surface 113a-2, the second inclined surface 113b-2, and the contact surface 113c-2 may each be formed in a flat shape.

As an example, the protrusion portion 113-2 may be formed such that a length thereof in the Z direction is longer than a length thereof in the X direction. However, the protrusion portion 113-2 is not limited thereto and may have various lengths depending on directions.

As an example, the protrusion portion 113-2 may be formed integrally with the cover portion 111-2.

As an example, the protrusion portion 113-2 may be manufactured using forming processing in which a sheet metal is pressed using a mold.

However, the protrusion portion 113-2 is not limited thereto, and may be manufactured using various manufacturing methods and may be formed as a component distinct from the cover portion 111-2.

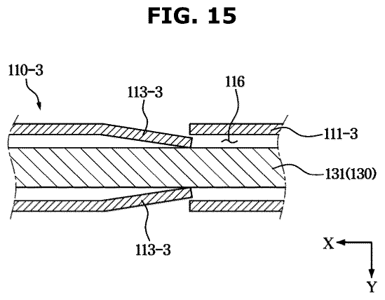

FIG. 15 is an enlarged cross-sectional view illustrating that the hinge assembly of the cooking apparatus according to an embodiment of the present disclosure is cut in the transverse direction and enlarged.

Components of the embodiment illustrated in FIG. 15 that are the same as those of the embodiments illustrated in FIGS. 1 to 13 may be given the same reference numerals, and descriptions thereof may be omitted.

Referring to FIG. 15, in the hinge assembly 100 of the cooking apparatus 1 according to an embodiment of the present disclosure, at least a portion of the hinge link 130 may be accommodated inside a main body bracket 110-3. In detail, the main body coupling portion 131 of the hinge link 130 may be accommodated in the accommodation space 116 inside the main body bracket 110-3.

The main body bracket 110-3 may include a protrusion portion 113-3 provided to prevent the hinge link 130 from moving. The protrusion portion 113-3 may be formed to protrude toward the at least a portion of the hinge link 130 accommodated in the main body bracket 110-3. In other words, the protrusion portion 113-3 may protrude toward the main body coupling portion 131 accommodated in the accommodation space 116 of the main body bracket 110-3.

The protrusion portion 113-3 may be provided on an inner side of the main body bracket 110-3. The protrusion portion 113-3 may protrude from a cover portion 111-3. The protrusion portion 113-3 may protrude from the cover portion 111-3 in the inner direction of the accommodation space 116. The protrusion portion 113-3 may protrude from the cover portion 111-3 toward at least a portion (that is, the main body coupling portion 131) of the hinge link 130 accommodated in the accommodation space 116.

The protrusion portion 113-3 may support the hinge link 130. In detail, the protrusion portion 113-3 may support the hinge link 130 by being in contact with the main body coupling portion 131 of the hinge link 130 so that the hinge link 130 does not move relative to the main body bracket 110-3. That is, the protrusion portion 113-3 may restrict the movement of the hinge link 130 so that the hinge link 130 does not move relative to the main body bracket 110-3.

The protrusion portion 113-3 may restrict the hinge link 130 from moving in a direction different from a direction in which the main body coupling portion 131 is inserted into the main body bracket 110-3 in a process of coupling the hinge link 130 and the main body bracket 110-3.

When the door bracket 120 and the main body bracket 110-3 are arranged to face each other in the first direction, the protrusion portion 113-3 may be provided to prevent the hinge link 130 from moving in the second direction different from the first direction. The protrusion portion 113-3 may protrude from the cover portion 111-3 in a direction parallel to the second direction and may support the hinge link 130 in the direction parallel to the second direction.

Herein, the first direction may be parallel to the direction in which the main body coupling portion 131 is inserted into the main body bracket 110-3 in the process of coupling the hinge link 130 and the main body bracket 110-3. The first direction may also be parallel to the direction in which the main body 10 and the door 30 face each other. The first direction may also be parallel to the front-rear direction of the cooking apparatus 1.

Herein, the second direction may be parallel to a direction in which a pair of side plates of the cover portion 111-3 face each other. The second direction may also be parallel to the direction in which the plurality of hinge assemblies 100a and 100b (see FIG. 2) is arranged. The second direction may also be parallel to the direction of the rotation shaft of the door 30. The second direction may also be parallel to the left-right direction of the cooking apparatus 1.

More specifically, the first direction and the second direction may be orthogonal to each other. For example, based on the drawing, the first direction may be the X direction (the front-rear direction of the cooking apparatus 1), and the second direction may be the Y direction (the left-right direction of the cooking apparatus 1). As illustrated in FIG. 15, the protrusion portion 113-3 may restrict the movement of the hinge link 130 in the Y direction.

However, the second direction in which the protrusion portion 113-3 restricts the movement of the hinge link 130 is not limited to that described above, and may vary depending on a shape or size of the inside of the main body bracket 110-3 or the shape or size of the main body coupling portion 131 of the hinge link 130.

Hereinafter, for convenience of explanation, an embodiment will be described as an example in which the first direction is parallel to the front-rear direction of the cooking apparatus 1 and the second direction is parallel to the left-right direction of the cooking apparatus 1.

As an example, the protrusion portion 113-3 may include a pair of the protrusion portions 113-3 arranged to face each other. A distance between the pair of protrusion portions 113-3 may correspond to a thickness of at least a portion of the hinge link 130 accommodated in the main body bracket 110-3, that is, a thickness of the main body coupling portion 131. Herein, a distance between the pair of protrusion portions 113-3 refers to the shortest distance between the pair of protrusion portions 113-3.

As an example, the pair of protrusion portions 113-3 may be arranged in the Y direction of the cooking apparatus 1. That is, the pair of protrusion portions 113-3 may be arranged in the left-right direction of the main body 10. The pair of protrusion portions 113-3 may be arranged to face each other in the Y direction.

In this case, one protrusion portion of the pair of protrusion portions 113-3 may be in contact with the left side of the hinge link 130, and the other protrusion portion of the pair of protrusion portions 113-3 may be in contact with the right side of the hinge link 130.

However, the number of the protrusion portions 113-3 provided on the main body bracket 110-3 is not limited thereto, and for example, the main body bracket 110-3 may be provided with only a single protrusion portion, or may be provided with three or more protrusion portions.

With the above configuration, the main body bracket 110-3 of the hinge assembly 100 may prevent the hinge link 130 from moving relative to the main body bracket 110-3 by including the protrusion portion 113-3.

The protrusion portion 113-3 may be disposed to be spaced apart from one end of the cover portion 111-3 on the door bracket 120 side. In detail, the protrusion portion 113-3 may be disposed further rearward in the X direction than the one end of the cover portion 111-3 on the door bracket 120 side.

The one end of the cover portion 111-3 on the door bracket 120 side may be disposed to be spaced apart from the hinge link 130. Also, at least a portion of the cover portion 111-3 positioned between the one end of the cover portion 111-3 on the door bracket 120 side and the protrusion portion 113-3 may be spaced apart from the hinge link 130. With this configuration, the main body coupling portion 131 may be easily inserted into the main body bracket 110-3 in the process of coupling the hinge link 130 and the main body bracket 110-3.

The protrusion portion 113-3 may extend to become close to the hinge link 130 as the protrusion portion becomes away from the door bracket 120. The protrusion portion 113-3 may extend such that a length thereof protruding from the cover portion 111-3 becomes long and to become close to the main body coupling portion 131 of the hinge link 130, as the protrusion portion becomes away from the door bracket 120. The protrusion portion 113-3 may extend to protrude toward the inner side of the accommodation space 116 in the Y direction as the first inclined surface faces rearward in the X direction. The protrusion portion 113-3 may extend to be inclined in the front-rear direction of the cooking apparatus 1.

A rear end of the protrusion portion 113-3 in the X direction may come into contact with the main body coupling portion 131.

As illustrated in FIG. 15, the protrusion portion 113-3 may extend to have a certain inclination angle with respect to the X direction, but an extension direction of the protrusion portion 113-3 is not limited thereto.

As an example, the protrusion portion 113-3 may be formed integrally with the cover portion 111-3.

As an example, the protrusion portion 113-3 may be manufactured using lancing processing in which a portion of the sheet metal is cut out and pressed into a mold.

However, the protrusion portion 113-3 is not limited thereto, and may be manufactured using various manufacturing methods and may be formed as a component distinct from the cover portion 111-3.

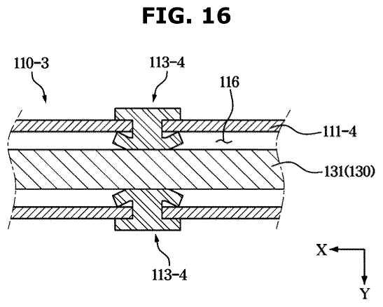

FIG. 16 is an enlarged cross-sectional view illustrating that the hinge assembly of the cooking apparatus according to an embodiment of the present disclosure is cut in the transverse direction and enlarged.

Components of the embodiment illustrated in FIG. 16 that are the same as those of the embodiments illustrated in FIGS. 1 to 13 may be given the same reference numerals, and descriptions thereof may be omitted.

Referring to FIG. 16, in the hinge assembly 100 of the cooking apparatus 1 according to an embodiment of the present disclosure, at least a portion of the hinge link 130 may be accommodated inside a main body bracket 110-4. In detail, the main body coupling portion 131 of the hinge link 130 may be accommodated in the accommodation space 116 inside the main body bracket 110-4.

The main body bracket 110-4 may include a protrusion member 113-4 provided to prevent the hinge link 130 from moving. The protrusion member 113-4 may be formed to protrude toward the at least a portion of the hinge link 130 accommodated in the main body bracket 110-4. In other words, the protrusion member 113-4 may protrude toward the main body coupling portion 131 accommodated in the accommodation space 116 of the main body bracket 110-4.

As illustrated in FIG. 16, the protrusion member 113-4 may be coupled to a cover portion 111-4 of the main body bracket 110-4. The protrusion member 113-4 may be composed of a distinct component from the cover portion 111-4.

At least a portion of the protrusion member 113-4 may be positioned on an inner side of the main body bracket 110-4. The at least a portion of the protrusion member 113-4 may be positioned further inward than the cover portion 111-4, and may protrude from the cover portion 111-4 toward at least a portion (that is, the main body coupling portion 131) of the hinge link 130 accommodated in the accommodation space 116.

The protrusion member 113-4 may support the hinge link 130. In detail, the at least a portion of the protrusion member 113-4 disposed on the inner side of the main body bracket 110-4 may support the hinge link 130 by being in contact with the main body coupling portion 131 of the hinge link 130 so that the hinge link 130 does not move relative to the main body bracket 110-4. That is, the protrusion member 113-4 may restrict the movement of the hinge link 130 so that the hinge link 130 does not move relative to the main body bracket 110-4.

The protrusion member 113-4 may restrict the hinge link 130 from moving in a direction different from a direction in which the main body coupling portion 131 is inserted into the main body bracket 110-4 in a process of coupling the hinge link 130 and the main body bracket 110-4.

When the door bracket 120 and the main body bracket 110-4 are arranged to face each other in the first direction, the protrusion member 113-4 may be provided to prevent the hinge link 130 from moving in the second direction different from the first direction.

Herein, the first direction may be parallel to the direction in which the main body coupling portion 131 is inserted into the main body bracket 110-4 in the process of coupling the hinge link 130 and the main body bracket 110-4. The first direction may also be parallel to the direction in which the main body 10 and the door 30 face each other. The first direction may also be parallel to the front-rear direction of the cooking apparatus 1.

Herein, the second direction may be parallel to a direction in which a pair of side plates of the cover portion 111-4 face each other. The second direction may also be parallel to the direction in which the plurality of hinge assemblies 100a and 100b (see FIG. 2) is arranged. The second direction may also be parallel to the direction of the rotation shaft of the door 30. The second direction may also be parallel to the left-right direction of the cooking apparatus 1.

More specifically, the first direction and the second direction may be orthogonal to each other. For example, based on the drawing, the first direction may be the X direction (the front-rear direction of the cooking apparatus 1), and the second direction may be the Y direction (the left-right direction of the cooking apparatus 1). As illustrated in FIG. 16, the protrusion member 113-4 may restrict the movement of the hinge link 130 in the Y direction.

However, the second direction in which the protrusion member 113-4 restricts the movement of the hinge link 130 is not limited to that described above, and may vary depending on a shape or size of the inside of the main body bracket 110-4 or the shape or size of the main body coupling portion 131 of the hinge link 130.

Hereinafter, for convenience of explanation, an embodiment will be described as an example in which the first direction is parallel to the front-rear direction of the cooking apparatus 1 and the second direction is parallel to the left-right direction of the cooking apparatus 1.

As an example, the protrusion member 113-4 may be disposed to penetrate the cover portion 111-4. At least one portion of the protrusion member 113-4 may be disposed on an inner side of the main body bracket 110-4, and at least other portion of the protrusion member 113-4 may be disposed on an outer side of the main body bracket 110-4. The at least one portion of the protrusion member 113-4 positioned on the inner side of the main body bracket 110-4 may be formed such that a width thereof in the X direction is wider than a width of a hole of the cover portion 111-4 in the X direction through which the protrusion member 113-4 penetrates. The at least other portion of the protrusion member 113-4 positioned on the outer side of the main body bracket 110-4 may be formed such that a width thereof in the X direction is wider than the width of the hole of the cover portion 111-4 in the X direction through which the protrusion member 113-4 penetrates.

As an example, the protrusion member 113-4 may include a pair of the protrusion members 113-4 arranged to face each other. A distance between the pair of protrusion members 113-4 may correspond to a thickness of at least a portion of the hinge link 130 accommodated in the main body bracket 110-4, that is, the thickness of the main body coupling portion 131. Herein, a distance between the pair of protrusion members 113-4 refers to the shortest distance between the pair of protrusion members 113-4.

As an example, the pair of protrusion members 113-4 may be arranged in the Y direction of the cooking apparatus 1. That is, the pair of protrusion members 113-4 may be arranged in the left-right direction of the main body 10. The pair of protrusion members 113-4 may be arranged to face each other in the Y direction.

In this case, one protrusion member of the pair of protrusion members 113-4 may be in contact with the left side of the hinge link 130, and the other protrusion member of the pair of protrusion members 113-4 may be in contact with the right side of the hinge link 130.

However, the number of the protrusion members 113-4 provided on the main body bracket 110-4 is not limited thereto, and for example, the main body bracket 110-4 may be provided with only a single protrusion member, or may be provided with three or more protrusion members.

The protrusion member 113-4 may be disposed to be spaced apart from one end of the cover portion 111-4 on the door bracket 120 side. In detail, the protrusion member 113-4 may be disposed further rearward in the X direction than the one end of the cover portion 111-4 on the door bracket 120 side.

The one end of the cover portion 111-4 on the door bracket 120 side may be disposed to be spaced apart from the hinge link 130. Also, at least a portion of the cover portion 111-4 positioned between the one end of the cover portion 111-4 on the door bracket 120 side and the protrusion member 113-4 may be spaced apart from the hinge link 130.

With the above configuration, the main body bracket 110-4 of the hinge assembly 100 may prevent the hinge link 130 from moving relative to the main body bracket 110-4 by including the protrusion member 113-4. The “at least a portion of the protrusion member 113-4 disposed on the inner side of the main body bracket 110-4” described above may have a configuration corresponding to the “protrusion portion 113” of the embodiment described with reference to FIGS. 11 to 13, etc., and may provide a corresponding function.

As an example, at least a portion of the protrusion member 113-4 disposed on the inner side of the main body bracket 110-4 may include a first inclined surface extending to become close to the hinge link 130 as the first inclined surface becomes away from the door bracket 120, a second inclined surface extending to become away from the hinge link 130 as the second inclined surface becomes away from the door bracket 120, and a contact surface disposed between the first and second inclined surfaces and in contact with the hinge link 130.

However, the protrusion member 113-4 described with reference to FIG. 16 is only an example of a protrusion member that is provided as a component distinct from the cover portion in the hinge assembly of the cooking apparatus according to the present disclosure and is coupled to the cover portion, and the present disclosure is not limited thereto. For example, a protrusion member provided as a component distinct from the cover portion 111-4 of the main body bracket 110-4 and coupled to the cover portion 111-4 may be formed to include a shape corresponding to the protrusion portions 113-2 and 113-3 described with reference to FIGS. 14 and 15.

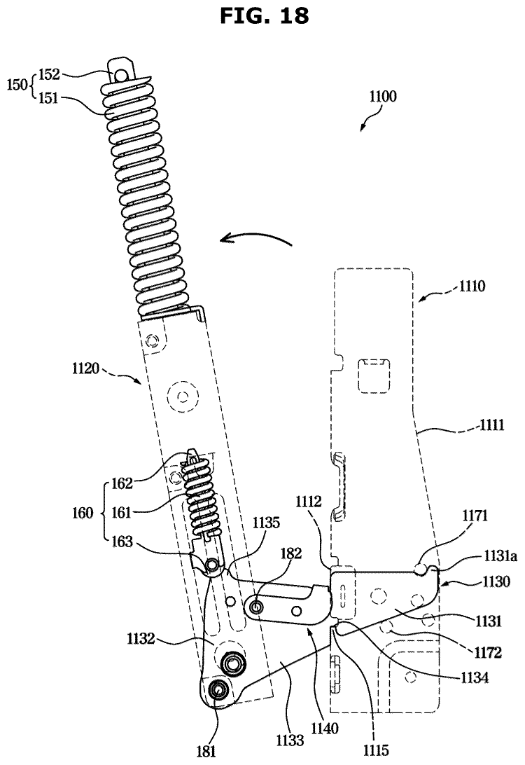

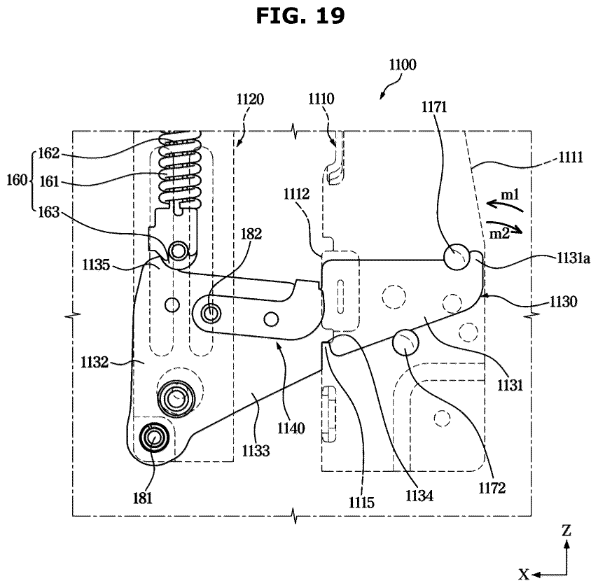

FIG. 17 is a view illustrating a hinge assembly when a door closes a cooking chamber in the cooking apparatus according to an embodiment of the present disclosure. FIG. 18 is a view illustrating the hinge assembly when the door partially opens the cooking chamber in the cooking apparatus according to an embodiment of the present disclosure. FIG. 19 is an enlarged view of some components of the hinge assembly of the cooking apparatus according to an embodiment of the present disclosure.

Components of the embodiment illustrated in FIGS. 17 to 19 that are the same as those of the embodiments illustrated in FIGS. 1 to 16 may be given the same reference numerals, and descriptions thereof may be omitted.

Referring to FIGS. 17 to 19, the cooking apparatus 1 according to an embodiment of the present disclosure may include the hinge assembly 1100 configured to connect the door 30 and the main body 10.

The hinge assembly 1100 may include the main body bracket 1110 coupled to the main body 10 and a door bracket 1120 coupled to the door 30.

The main body bracket 1110 of FIGS. 17 to 19 may have features corresponding to the configuration, function, etc., of the main body bracket 110 described in the embodiments of FIGS. 1 to 16, and a detailed description thereof will be omitted.

Similarly, the door bracket 1120 of FIGS. 17 to 19 may have features corresponding to the configuration, function, etc., of the door bracket 120 described in the embodiments of FIGS. 1 to 16, and a detailed description thereof will be omitted.

The hinge assembly 1100 may include the hinge link 1130 configured to connect the main body bracket 1110 and the door bracket 1120. The hinge link 1130 may support the door bracket 1120 such that the door bracket 1120 is rotatable relative to the main body bracket 1110.

At least a portion of the hinge link 1130 may be accommodated inside the main body bracket 1110. The hinge link 1130 may penetrate a coupling hole 1112 of the main body bracket 1110. The at least a portion of the hinge link 1130 accommodated inside the main body bracket 1110 may be covered by the cover portion 1111.

The hinge link 1130 may include a main body coupling portion 1131 coupled to the main body bracket 1110. The main body coupling portion 1131 may be fixed to the main body bracket 1110. The main body coupling portion 1131 may be accommodated inside the main body bracket 1110.

The hinge link 1130 may include a door coupling portion 1132 coupled to the door bracket 1120. The door bracket 1120 may be coupled to the door coupling portion 1132 by the door rotation shaft 181. The door bracket 1120 may rotate relative to the hinge link 1130 about the door rotation shaft 181.

The hinge link 1130 may include an intermediate portion 1133 positioned between the main body coupling portion 1131 and the door coupling portion 1132.

Hereinafter, a structure of the hinge assembly 1100 for fixing the hinge link 1130 to the main body bracket 1110 will be described in detail.

The hinge assembly 1100 may include a first supporter 1171 configured to support one side of the hinge link 1130. The first supporter 1171 may be configured to support the one side of the hinge link 1130 to prevent the hinge link 1130 from moving in a first direction m1 relative to the main body bracket 1110. The first supporter 1171 may also be configured to support the one side of the hinge link 1130 to prevent the hinge link 1130 from moving in the Z direction relative to the main body bracket 1110.

In detail, the first supporter 1171 may prevent the hinge link 1130 from rotating in the first direction m1 relative to the main body bracket 1110. For example, the first direction m1 may be a counterclockwise direction based on FIG. 19, etc.

As an example, the first supporter 1171 may support at least a portion of the hinge link 1130 accommodated in the main body bracket 1110, that is, the main body coupling portion 1131 on an upper side. The first supporter 1171 may prevent the main body coupling portion 1131 from moving upward and from rotating in the first direction m1.

The hinge link 1130 may include a winding portion 1131a formed to surround at least a portion of an outer surface of the first supporter 1171. The winding portion 1131a may be provided in the main body coupling portion 1131.

As an example, the winding portion 1131a may be provided on an upper side of the main body coupling portion 1131. As an example, the winding portion 1131a may be provided at the rear of the main body coupling portion 1131 in the X direction.

The first supporter 1171 may be disposed to penetrate the main body bracket 1110. The first supporter 1171 may penetrate a pair of side plates of the cover portion 1111 in the Y direction.

As an example, the first supporter 1171 may be composed of a rivet.

The hinge assembly 1100 may include an elastic system configured to enable the efficient rotational movement of the door 30 when the door 30 opens or closes the cooking chamber 20. A description of the elastic system of the hinge assembly 1100 illustrated in FIGS. 17 to 19 is the same as the description of the elastic system of the hinge assembly 100 of the embodiments illustrated in FIGS. 1 to 16, and a detailed description thereof will be omitted.

The door coupling portion 1132 may be provided with a roller contact portion 1135 provided to be in contact with the roller 163 of the second elastic member 160. As the door bracket 1120 rotates by the hinge link 1130 when the door 30 rotates, the roller 163 may move on the roller contact portion 1135. The degree of the elastic force accumulated in the second elastic spring 161 may vary depending on a relative position of the roller 163 with respect to the roller contact portion 1135.

Referring to FIGS. 18 and 19, when the door 30 rotates to open the cooking chamber 20 (see FIG. 19) from a position of closing the cooking chamber 20 (see FIG. 18), the relative position of the roller 163 with respect to the roller contact portion 1135 may be moved. For example, when the door 30 rotates from a position illustrated in FIG. 18 to a position illustrated in FIG. 19, the second elastic spring 161 may receive a force in a compressed direction. As a reaction to this, the roller contact portion 1135 may receive the force from the roller 163.

The main body bracket 1110 may include a link support portion 1115 provided at one end of the main body bracket 1110 on the door bracket 1120 side and provided to support the hinge link 1130. The link support portion 1115 may support a portion of the hinge link 130 corresponding to the main body coupling portion 1131 and the intermediate portion 1133. The link support portion 1115 of the embodiment illustrated in FIGS. 17 to 19 may have features corresponding to the link support portion 115 of the embodiments illustrated in FIGS. 1 to 16, and a detailed description thereof will be omitted.

The hinge link 1130 may include a support groove 1134 formed to correspond to the link support portion 1115. The support groove 1134 may be formed to engage with and be coupled to the link support portion 1115. The support groove 1134 of the embodiment illustrated in FIGS. 17 to 19 may have features corresponding to the support groove 134 of the embodiments illustrated in FIGS. 1 to 16, and a detailed description thereof will be omitted.

As described above, when the door 30 rotates from the position illustrated in FIG. 18 to the position illustrated in FIG. 19, the roller contact portion 1135 may receive the force from the roller 163. Or, the roller contact portion 1135 may receive the force from the roller 163 for various reasons, such as in cases in which an external force for rotating the door 30 in the closing direction is not sufficient when the door 30 rotates in the direction of closing the cooking chamber 20, and the second elastic member 160 functions as a damper to reduce a rotational speed of the door 30 when the door 30 rotates in the direction of closing the cooking chamber 20.

A problem may occur in that the hinge link 1130 moves relative to the main body bracket 1110 due to the force received from the roller 163 by the roller contact portion 1135. In particular, a further problem may occur because a point at which the link support portion 1115 and the support groove 1134 are engaged with each other may also function as a rotation axis that causes the hinge link 1130 to rotate in a second direction m2 relative to the main body bracket 1110.

In addition, the hinge link 1130 may receive an external force to move relative to the main body bracket 1110 due to various causes, such as opening and closing of the door 30 or an external impact.

In order to prevent these problems, the hinge assembly 1100 may include a second supporter 1172 configured to support the other side of the hinge link 1130. The second supporter 1172 may be configured to support the other side of the hinge link 1130 to prevent the hinge link 1130 from moving in the second direction m2 different from the first direction m1 relative to the main body bracket 1110. The second supporter 1172 may also be configured to support the other side of the hinge link 1130 to prevent the hinge link 1130 from moving in the Z direction relative to the main body bracket 1110.

As an example, the first direction m1, which is a direction in which the hinge link 1130 is restricted from moving by the first supporter 1171, may be opposite to the second direction m2, which is a direction in which the hinge link 1130 is restricted from moving by the second supporter 1172.

In detail, the second supporter 1172 may prevent the hinge link 1130 from rotating in the second direction m2 relative to the main body bracket 1110. For example, the second direction m2 may be a clockwise direction based on FIG. 19, etc.

As an example, the second supporter 1172 may support at least a portion of the hinge link 1130 accommodated in the main body bracket 1110, that is, the main body coupling portion 1131 on a lower side. The second supporter 1172 may prevent the main body coupling portion 1131 from moving downward and from rotating in the second direction m2.

The second supporter 1172 may be disposed to penetrate the main body bracket 1110. The second supporter 1172 may penetrate the pair of side plates of the cover portion 1111 in the Y direction.

As an example, the second supporter 1172 may be composed of a rivet.

With this configuration, the hinge assembly 1100 may be configured such that the hinge link 1130 is stably supported relative to the main body bracket 1110 by including the first supporter 1171 supporting the one side of the hinge link 1130 and the second supporter 1172 supporting the other side of the hinge link 1130.

Additionally, the hinge assembly 1100 including the first supporter 1171 and the second supporter 1172 may prevent the door 30 from deviating the designed position.

Additionally, the hinge assembly 1100 including the first supporter 1171 and the second supporter 1172 may reduce noise or vibration occurring due to the movement of the hinge link 1130 when the door 30 rotates.

Furthermore, the hinge assembly 1100 may further include the locking member 1140 configured to fix the door bracket 1120 in the position when the door 30 closes the cooking chamber 20.

The locking member 1140 may be coupled to the hinge link 1130. As an example, the locking member 1140 may be coupled to the hinge link 1130 by the coupling shaft 182. In detail, the locking member 1140 may be coupled to the hinge link 1130 to be rotatable about the coupling shaft 182.

The locking member 1140 may be supported on the main body bracket 1110. In detail, the locking member 1140 may come into contact with the main body bracket 1110 in the X direction. Accordingly, the locking member 1140 may restrict the door bracket 1120 from moving in the X direction from a designed position when the door 30 is in the position of closing the cooking chamber 20.

The hinge assembly 1100 may support the door 30 more stably by including the locking member 1140.

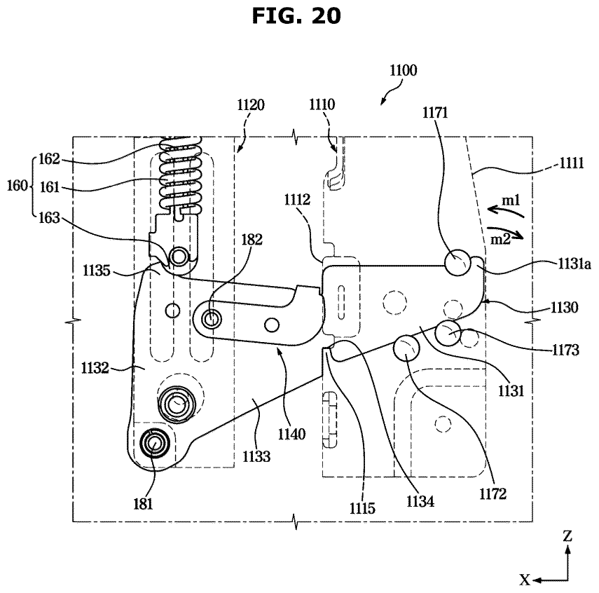

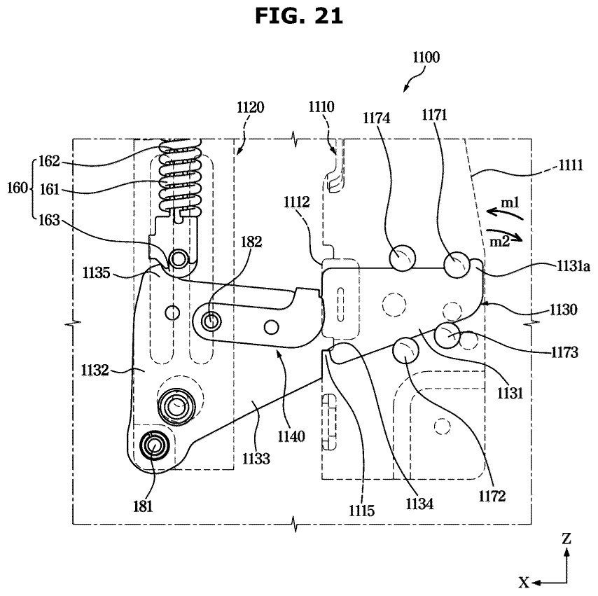

FIG. 20 is an enlarged view of some components of the hinge assembly of the cooking apparatus according to an embodiment of the present disclosure. FIG. 21 is an enlarged view of some components of the hinge assembly of the cooking apparatus according to an embodiment of the present disclosure.

Components of the embodiment illustrated in FIGS. 20 and 21 that are the same as those of the embodiments illustrated in FIGS. 1 to 19 may be given the same reference numerals, and descriptions thereof may be omitted.

Referring to FIGS. 20 and 21, the hinge assembly 1100 of the cooking apparatus 1 according to an embodiment of the present disclosure may further include a third supporter 1173 configured to support the other side of the hinge link 1130 supported by the second supporter 1172.

The third supporter 1173 may prevent the hinge link 1130 from moving in the second direction m2 relative to the main body bracket 1110. The third supporter 1173 may prevent the hinge link 1130 from moving in the Z direction relative to the main body bracket 1110.

As an example, the second direction m2 may be the clockwise direction based on FIGS. 20 and 21, etc.

As an example, the third supporter 1173 may support at least a portion of the hinge link 1130 accommodated in the main body bracket 1110, that is, the main body coupling portion 1131 on the lower side. The third supporter 1173 may prevent the main body coupling portion 1131 from moving downward and from rotating in the second direction m2.

The third supporter 1173 may be disposed to penetrate the main body bracket 1110. The third supporter 1173 may penetrate the pair of side plates of the cover portion 1111 in the Y direction.

As an example, the third supporter 1173 may be composed of a rivet.

As the hinge assembly 1100 further includes the third supporter 1173, the hinge link 1130 may be more efficiently prevented from moving in the second direction m2.

Referring to FIG. 21, the hinge assembly 1100 of the cooking apparatus 1 according to an embodiment of the present disclosure may further include a fourth supporter 1174 configured to support the one side of the hinge link 1130 supported by the first supporter 1171.

The fourth supporter 1174 may prevent the hinge link 1130 from moving in the first direction m1 relative to the main body bracket 1110. The fourth supporter 1174 may prevent the hinge link 1130 from moving in the Z direction relative to the main body bracket 1110.

As an example, the first direction m1 may be the counterclockwise direction based on FIG. 21, etc.

As an example, the fourth supporter 1174 may support at least a portion of the hinge link 1130 accommodated in the main body bracket 1110, that is, the main body coupling portion 1131 on the upper side. The fourth supporter 1174 may prevent the main body coupling portion 1131 from moving downward and from rotating in the first direction m1.

The fourth supporter 1174 may be disposed to penetrate the main body bracket 1110. The fourth supporter 1174 may penetrate the pair of side plates of the cover portion 1111 in the Y direction.

As an example, the fourth supporter 1174 may be composed of a rivet.

As the hinge assembly 1100 further includes the fourth supporter 1174, the hinge link 1130 may be more efficiently prevented from moving in the first direction m1.

Unlike illustrated in FIGS. 20 and 21, the hinge assembly 1100 of the cooking apparatus 1 according to an embodiment may not include the third supporter 1173 but may include only the fourth supporter 1174.

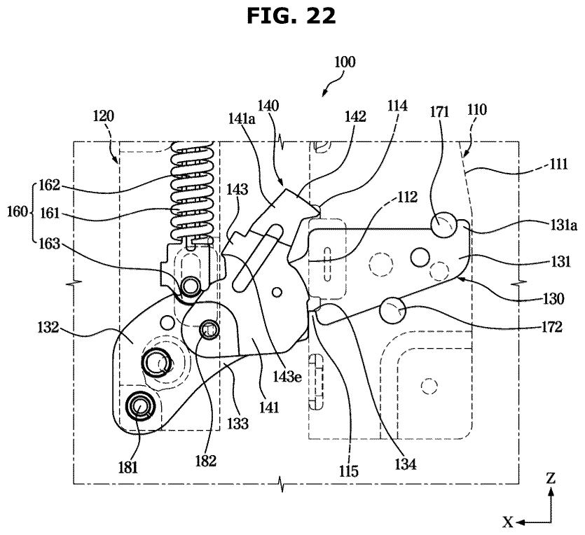

FIG. 22 is an enlarged view of some components of the hinge assembly of the cooking apparatus according to an embodiment of the present disclosure.

Components of the embodiment illustrated in FIG. 22 that are the same as those of the embodiments illustrated in FIGS. 1 to 19 may be given the same reference numerals, and descriptions thereof may be omitted.

In particular, descriptions of the embodiment illustrated in FIG. 22, which overlap with the embodiment illustrated in FIGS. 1 to 7, will be omitted.

Referring to FIG. 22, the hinge assembly 100 may include a first supporter 171 configured to support one side of the hinge link 130. The first supporter 171 may be configured to support the one side of the hinge link 130 to prevent the hinge link 130 from moving in the first direction m1 relative to the main body bracket 110. The first supporter 171 may also be configured to support the one side of the hinge link 130 to prevent the hinge link 130 from moving in the Z direction relative to the main body bracket 110.

In detail, the first supporter 171 may prevent the hinge link 130 from rotating in the first direction m1 relative to the main body bracket 110. For example, the first direction m1 may be the counterclockwise direction based on FIG. 22, etc.

As an example, the first supporter 171 may support at least a portion of the hinge link 130 accommodated in the main body bracket 110, that is, the main body coupling portion 131 on an upper side. The first supporter 171 may prevent the main body coupling portion 131 from moving upward and from rotating in the first direction m1.

The hinge link 130 may include a winding portion 131a formed to surround at least a portion of an outer surface of the first supporter 171. The winding portion 131a may be provided in the main body coupling portion 131.

As an example, the winding portion 131a may be provided on an upper side of the main body coupling portion 131. As an example, the winding portion 131a may be provided at the rear of the main body coupling portion 131 in the X direction.

The first supporter 171 may be disposed to penetrate the main body bracket 110. The first supporter 171 may penetrate the pair of side plates of the cover portion 111 in the Y direction.

As an example, the first supporter 171 may be composed of a rivet.

The hinge link 130 may receive an external force to move relative to the main body bracket 110 due to various causes, such as opening and closing of the door 30, a force from the second elastic member 160, and an impact from the outside. In particular, as described above, a further problem may occur because a point at which the link support portion 115 and the support groove 134 are engaged with each other may also function as a rotation axis that causes the hinge link 130 to rotate in the second direction m2 relative to the main body bracket 110.

In order to prevent these problems, the hinge assembly 100 may include a second supporter 172 configured to support the other side of the hinge link 130. The second supporter 172 may be configured to support the other side of the hinge link 130 to prevent the hinge link 130 from moving in the second direction m2 different from the first direction m1 relative to the main body bracket 110. The second supporter 172 may also be configured to support the other side of the hinge link 130 to prevent the hinge link 130 from moving in the Z direction relative to the main body bracket 110.

As an example, the first direction m1, which is a direction in which the hinge link 130 is restricted from moving by the first supporter 171, may be opposite to the second direction m2, which is a direction in which the hinge link 130 is restricted from moving by the second supporter 172.

In detail, the second supporter 172 may prevent the hinge link 130 from rotating in the second direction m2 relative to the main body bracket 110. For example, the second direction m2 may be the clockwise direction based on FIG. 22, etc.

As an example, the second supporter 172 may support at least a portion of the hinge link 130 accommodated in the main body bracket 110, that is, the main body coupling portion 131 on a lower side. The second supporter 172 may prevent the main body coupling portion 131 from moving downward and from rotating in the second direction m2.

The second supporter 172 may be disposed to penetrate the main body bracket 110. The second supporter 172 may penetrate the pair of side plates of the cover portion 111 in the Y direction.

As an example, the second supporter 172 may be composed of a rivet.

With this configuration, the hinge assembly 100 may be configured such that the hinge link 130 is stably supported relative to the main body bracket 110 by including the first supporter 171 supporting the one side of the hinge link 130 and the second supporter 172 supporting the other side of the hinge link 130.

Additionally, the hinge assembly 100 including the first supporter 171 and the second supporter 172 may prevent the door 30 from deviating the designed position.

Additionally, the hinge assembly 100 including the first supporter 171 and the second supporter 172 may reduce noise or vibration occurring due to the movement of the hinge link 130 when the door 30 rotates.

As described with reference to FIGS. 20 and 21, the hinge assembly 100 of FIG. 22 may also further include supporters, such as a third supporter and a fourth supporter, in addition to the first supporter 171 and the second supporter 172.

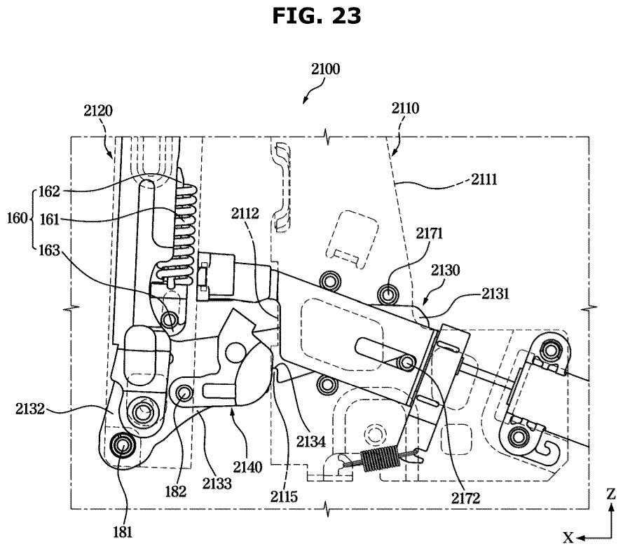

FIG. 23 is an enlarged view of some components of a hinge assembly of the cooking apparatus according to an embodiment of the present disclosure.

Components of the embodiment illustrated in FIG. 23 that are the same as those of the embodiments illustrated in FIGS. 1 to 19 may be given the same reference numerals, and descriptions thereof may be omitted.

Referring to FIG. 23, the cooking apparatus 1 according to an embodiment of the present disclosure may include a hinge assembly 2100 configured to connect the door 30 and the main body 10.

The hinge assembly 2100 may include a main body bracket 2110 coupled to the main body 10 and a door bracket 2120 coupled to the door 30.

The main body bracket 2110 of FIG. 23 may have features corresponding to the configuration, function, etc., of the main body bracket 110 described in the embodiments of FIGS. 1 to 16, and a detailed description thereof will be omitted.

Similarly, the door bracket 2120 of FIG. 23 may have features corresponding to the configuration, function, etc., of the door bracket 120 described in the embodiments of FIGS. 1 to 16, and a detailed description thereof will be omitted.

The hinge assembly 2100 may include a hinge link 2130 configured to connect the main body bracket 2110 and the door bracket 2120. The hinge link 2130 may support the door bracket 2120 such that the door bracket 2120 is rotatable relative to the main body bracket 2110.

At least a portion of the hinge link 2130 may be accommodated inside the main body bracket 2110. The hinge link 2130 may penetrate a coupling hole 2112 of the main body bracket 2110. The at least a portion of the hinge link 2130 accommodated inside the main body bracket 2110 may be covered by a cover portion 2111.

The hinge link 2130 may include a main body coupling portion 2131 coupled to the main body bracket 2110. The main body coupling portion 2131 may be fixed to the main body bracket 2110. The main body coupling portion 2131 may be accommodated inside the main body bracket 2110.

The hinge link 2130 may include a door coupling portion 2132 coupled to the door bracket 2120. The door bracket 2120 may be coupled to the door coupling portion 2132 by the door rotation shaft 181. The door bracket 2120 may rotate relative to the hinge link 2130 about the door rotation shaft 181.

The hinge link 2130 may include an intermediate portion 2133 positioned between the main body coupling portion 2131 and the door coupling portion 2132.

Hereinafter, a structure of the hinge assembly 2100 for fixing the hinge link 2130 to the main body bracket 2110 will be described in detail.

Referring to FIG. 23, the hinge assembly 2100 may include a first supporter 2171 configured to support one side of the hinge link 2130. The first supporter 2171 may be configured to support the one side of the hinge link 2130 to prevent the hinge link 2130 from moving in the first direction m1 relative to the main body bracket 2110. The first supporter 2171 may also be configured to support the one side of the hinge link 2130 to prevent the hinge link 2130 from moving in the Z direction relative to the main body bracket 2110.

In detail, the first supporter 2171 may prevent the hinge link 2130 from rotating in the first direction m1 relative to the main body bracket 2110. For example, the first direction m1 may be the counterclockwise direction based on FIG. 23, etc.

As an example, the first supporter 2171 may support at least a portion of the hinge link 2130 accommodated in the main body bracket 2110, that is, the main body coupling portion 2131 on an upper side. The first supporter 2171 may prevent the main body coupling portion 2131 from moving upward and from rotating in the first direction m1.

The first supporter 2171 may be disposed to penetrate the main body bracket 2110. The first supporter 2171 may penetrate a pair of side plates of the cover portion 2111 in the Y direction.

As an example, the first supporter 2171 may be composed of a rivet.

The hinge link 2130 may receive an external force to move relative to the main body bracket 2110 due to various causes, such as opening and closing of the door 30, a force from the second elastic member 160, and an impact from the outside. In particular, as described above, a further problem may occur because a point at which a link support portion 2115 and a support groove 2134 are engaged with each other may also function as a rotation axis that causes the hinge link 2130 to rotate in the second direction m2 relative to the main body bracket 2110.

In order to prevent these problems, the hinge assembly 2100 may include a second supporter 2172 configured to support the other side of the hinge link 2130. The second supporter 2172 may be configured to support the other side of the hinge link 2130 to prevent the hinge link 2130 from moving in the second direction m2 different from the first direction m1 relative to the main body bracket 2110. The second supporter 2172 may also be configured to support the other side of the hinge link 2130 to prevent the hinge link 2130 from moving in the Z direction relative to the main body bracket 2110.

As an example, the first direction m1, which is a direction in which the hinge link 2130 is restricted from moving by the first supporter 2171, may be opposite to the second direction m2, which is a direction in which the hinge link 2130 is restricted from moving by the second supporter 2172.

In detail, the second supporter 2172 may prevent the hinge link 2130 from rotating in the second direction m2 relative to the main body bracket 2110. For example, the second direction m2 may be the clockwise direction based on FIG. 23, etc.

As an example, the second supporter 2172 may support at least a portion of the hinge link 2130 accommodated in the main body bracket 2110, that is, the main body coupling portion 2131 on a lower side. The second supporter 2172 may prevent the main body coupling portion 2131 from moving downward and from rotating in the second direction m2.

The second supporter 2172 may be disposed to penetrate the main body bracket 2110. The second supporter 2172 may penetrate the pair of side plates of the cover portion 2111 in the Y direction.

As an example, the second supporter 2172 may be composed of a rivet.

With this configuration, the hinge assembly 2100 may be configured such that the hinge link 2130 is stably supported relative to the main body bracket 2110 by including the first supporter 2171 supporting the one side of the hinge link 2130 and the second supporter 2172 supporting the other side of the hinge link 2130.

Additionally, the hinge assembly 2100 including the first supporter 2171 and the second supporter 2172 may prevent the door 30 from deviating the designed position.

Additionally, the hinge assembly 2100 including the first supporter 2171 and the second supporter 2172 may reduce noise or vibration occurring due to a movement of the hinge link 2130 when the door 30 rotates.

As described with reference to FIGS. 20 and 21, the hinge assembly 2100 of FIG. 23 may also further include supporters, such as a third supporter and a fourth supporter, in addition to the first supporter 2171 and the second supporter 2172.

Furthermore, the hinge assembly 2100 may further include a locking member 2140 configured to fix the door bracket 2120 in a position when the door 30 closes the cooking chamber 20.

The locking member 2140 may be coupled to the hinge link 2130. As an example, the locking member 2140 may be coupled to the hinge link 2130 by the coupling shaft 182. In detail, the locking member 2140 may be coupled to the hinge link 2130 to be rotatable about the coupling shaft 182.

The locking member 2140 may be supported on the main body bracket 2110. In detail, the locking member 2140 may come into contact with the main body bracket 2110 in the X direction. Accordingly, the locking member 2140 may restrict the door bracket 2120 from moving in the X direction from a designed position when the door 30 is in the position of closing the cooking chamber 20.

The hinge assembly 2100 may support the door 30 more stably by including the locking member 2140.

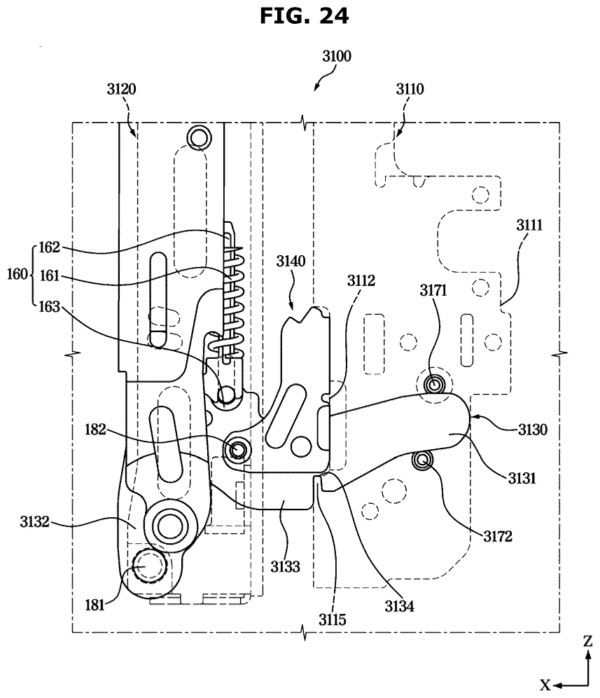

FIG. 24 is an enlarged view of some components of a hinge assembly of the cooking apparatus according to an embodiment of the present disclosure.

Components of the embodiment illustrated in FIG. 24 that are the same as those of the embodiments illustrated in FIGS. 1 to 19 may be given the same reference numerals, and descriptions thereof may be omitted.

Referring to FIG. 24, the cooking apparatus 1 according to an embodiment of the present disclosure may include a hinge assembly 3100 configured to connect the door 30 and the main body 10.

The hinge assembly 3100 may include a main body bracket 3110 coupled to the main body 10 and a door bracket 3120 coupled to the door 30.

The main body bracket 3110 of FIG. 24 may have features corresponding to the configuration, function, etc., of the main body bracket 110 described in the embodiments of FIGS. 1 to 16, and a detailed description thereof will be omitted.

Similarly, the door bracket 3120 of FIG. 24 may have features corresponding to the configuration, function, etc., of the door bracket 120 described in the embodiments of FIGS. 1 to 16, and a detailed description thereof will be omitted.

The hinge assembly 3100 may include a hinge link 3130 configured to connect the main body bracket 3110 and the door bracket 3120. The hinge link 3130 may support the door bracket 3120 such that the door bracket 3120 is rotatable relative to the main body bracket 3110.

At least a portion of the hinge link 3130 may be accommodated inside the main body bracket 3110. The hinge link 3130 may penetrate a coupling hole 3112 of the main body bracket 3110. The at least a portion of the hinge link 3130 accommodated inside the main body bracket 3110 may be covered by a cover portion 3111.

The hinge link 3130 may include a main body coupling portion 3131 coupled to the main body bracket 3110. The main body coupling portion 3131 may be fixed to the main body bracket 3110. The main body coupling portion 3131 may be accommodated inside the main body bracket 3110.

The hinge link 3130 may include a door coupling portion 3132 coupled to the door bracket 3120. The door bracket 3120 may be coupled to the door coupling portion 3132 by the door rotation shaft 181. The door bracket 3120 may rotate relative to the hinge link 3130 about the door rotation shaft 181.

The hinge link 3130 may include an intermediate portion 3133 positioned between the main body coupling portion 3131 and the door coupling portion 3132.

Hereinafter, a structure of the hinge assembly 3100 for fixing the hinge link 3130 to the main body bracket 3110 will be described in detail.

Referring to FIG. 24, the hinge assembly 3100 may include a first supporter 3171 configured to support one side of the hinge link 3130. The first supporter 3171 may be configured to support the one side of the hinge link 3130 to prevent the hinge link 3130 from moving in the first direction m1 relative to the main body bracket 3110. The first supporter 3171 may also be configured to support the one side of the hinge link 3130 to prevent the hinge link 3130 from moving in the Z direction relative to the main body bracket 3110.

In detail, the first supporter 3171 may prevent the hinge link 3130 from rotating in the first direction m1 relative to the main body bracket 3110. For example, the first direction m1 may be the counterclockwise direction based on FIG. 24, etc.

As an example, the first supporter 3171 may support at least a portion of the hinge link 3130 accommodated in the main body bracket 3110, that is, the main body coupling portion 3131 on an upper side. The first supporter 3171 may prevent the main body coupling portion 3131 from moving upward and from rotating in the first direction m1.

The first supporter 3171 may be disposed to penetrate the main body bracket 3110. The first supporter 3171 may penetrate a pair of side plates of the cover portion 3111 in the Y direction.

As an example, the first supporter 3171 may be composed of a rivet.

The hinge link 3130 may receive an external force to move relative to the main body bracket 3110 due to various causes, such as opening and closing of the door 30, a force from the second elastic member 160, and an impact from the outside. In particular, as described above, a further problem may occur because a point at which a link support portion 3115 and a support groove 3134 are engaged with each other may also function as a rotation axis that causes the hinge link 3130 to rotate in the second direction m2 relative to the main body bracket 3110.

In order to prevent these problems, the hinge assembly 3100 may include a second supporter 3172 configured to support the other side of the hinge link 3130. The second supporter 3172 may be configured to support the other side of the hinge link 3130 to prevent the hinge link 3130 from moving in the second direction m2 different from the first direction m1 relative to the main body bracket 3110. The second supporter 3172 may also be configured to support the other side of the hinge link 3130 to prevent the hinge link 3130 from moving in the Z direction relative to the main body bracket 3110.

As an example, the first direction m1, which is a direction in which the hinge link 3130 is restricted from moving by the first supporter 3171, may be opposite to the second direction m2, which is a direction in which the hinge link 3130 is restricted from moving by the second supporter 3172.

In detail, the second supporter 3172 may prevent the hinge link 3130 from rotating in the second direction m2 relative to the main body bracket 3110. For example, the second direction m2 may be the clockwise direction based on FIG. 24, etc.

As an example, the second supporter 3172 may support at least a portion of the hinge link 3130 accommodated in the main body bracket 3110, that is, the main body coupling portion 3131 on a lower side. The second supporter 3172 may prevent the main body coupling portion 3131 from moving downward and from rotating in the second direction m2.

The second supporter 3172 may be disposed to penetrate the main body bracket 3110. The second supporter 3172 may penetrate the pair of side plates of the cover portion 3111 in the Y direction.

As an example, the second supporter 3172 may be composed of a rivet.

With this configuration, the hinge assembly 3100 may be configured such that the hinge link 3130 is stably supported relative to the main body bracket 3110 by including the first supporter 3171 supporting the one side of the hinge link 3130 and the second supporter 3172 supporting the other side of the hinge link 3130.

Additionally, the hinge assembly 3100 including the first supporter 3171 and the second supporter 3172 may prevent the door 30 from deviating the designed position.

Additionally, the hinge assembly 3100 including the first supporter 3171 and the second supporter 3172 may reduce noise or vibration occurring due to a movement of the hinge link 3130 when the door 30 rotates.

As described with reference to FIGS. 20 and 21, the hinge assembly 3100 of FIG. 24 may also further include supporters, such as a third supporter and a fourth supporter, in addition to the first supporter 3171 and the second supporter 3172.

Furthermore, the hinge assembly 3100 may further include a locking member 3140 configured to fix the door bracket 3120 in a position when the door 30 closes the cooking chamber 20.

The locking member 3140 may be coupled to the hinge link 3130. As an example, the locking member 3140 may be coupled to the hinge link 3130 by the coupling shaft 182. In detail, the locking member 3140 may be coupled to the hinge link 3130 to be rotatable about the coupling shaft 182.

The locking member 3140 may be supported on the main body bracket 3110. In detail, the locking member 3140 may come into contact with the main body bracket 3110 in the X direction. Accordingly, the locking member 3140 may restrict the door bracket 3120 from moving in the X direction from a designed position when the door 30 is in the position of closing the cooking chamber 20.

The hinge assembly 3100 may support the door 30 more stably by including the locking member 3140.

A cooking apparatus 1 according to an embodiment of the present disclosure may include a main body 10 forming a cooking chamber 20, a door 30 configured to open and close the cooking chamber, and a hinge assembly 100 which connects the main body and the door. The hinge assembly may include a door bracket 120 coupled to the door, a main body bracket 110 coupled to the main body, a hinge link 130 which connects the door bracket and the main body bracket and support the door bracket so as to be rotatable, and a locking member 140 configured to be coupled to the hinge link and fix a position of the door bracket when the door closes the cooking chamber, the locking member including an engaging portion 142 which is engaged with and coupled to the main body bracket 110, and a deviation prevention portion 143 provided to interfere with the door bracket 120 to prevent the engaging portion from deviating from the main body bracket. According to the present disclosure, the locking member 140 may fix the door bracket 120 in the position when the door 30 closes the cooking chamber 20, and the hinge assembly 100 may stably support the door 30 and efficiently prevent the door 30 from deviating from a designed position.

The main body bracket 110 may include an insertion portion 114 into which at least a portion of the engaging portion is inserted. The engaging portion 142 may be engaged with and coupled to the main body bracket as at least a portion of the engaging portion is inserted into the insertion portion. According to the present disclosure, the locking member 140 may be more firmly fixed to the main body bracket 110 using the engaging portion 142.

A distance d1 between the door bracket 120 and the main body bracket 110 when the door closes the cooking chamber may be shorter than a distance d2 between one end of the engaging portion 142 in a direction of being inserted into the insertion portion and one end of the deviation prevention portion 143 interfering with the door bracket. According to the present disclosure, even if the engaging portion 142 moves in a direction of deviating from the insertion portion 114, the deviation prevention portion 143 may interfere with the door bracket 120 before the engaging portion 142 completely deviates from the insertion portion 114.

The locking member 140 may be provided to be positioned between a first position in which the engaging portion is maximally inserted into the insertion portion and a second position in which the engaging portion moves in a direction of deviating from the insertion portion at the first position. The deviation prevention portion 143 may be provided to come into contact with the door bracket 120 when the door closes the cooking chamber and the locking member is in the second position. According to the present disclosure, even if the engaging portion 142 moves in the direction of deviating from the insertion portion 114, the deviation prevention portion 143 may interfere with the door bracket 120 before the engaging portion 142 completely deviates from the insertion portion 114. In addition, when the locking member 140 is in the first position, the deviation prevention portion 143 may be prevented from unnecessarily interfering with the door bracket 120.

The deviation prevention portion 143 may extend in a direction away from the door bracket from a tip 143e coming into contact with the door bracket at the second position when the door closes the cooking chamber. According to the present disclosure, not only unnecessary interference between the deviation prevention portion 143 and the door bracket 120 may be prevented, but also a load applied to the deviation prevention portion 143 may be distributed.

The locking member may include a locking body 141 coupled to the hinge link. The engaging portion 142 may protrude from the locking body 141 toward an inner side of the insertion portion 114. According to the present disclosure, the locking member 140 may be more firmly fixed to the main body bracket 110. In addition, even if the locking member 140 moves relative to the main body bracket 110, the engaging portion 142 may not easily deviate from the insertion portion 114.

The locking member may include a locking body 141 coupled to the hinge link. The deviation prevention portion 143 may protrude from the locking body 141 in a direction opposite to the main body bracket. According to the present disclosure, the deviation prevention portion 143 may interfere with the door bracket 120 even when the locking member 140 rotates only a small angle about a coupling shaft 182.

The locking member may be configured to be rotatable relative to the hinge link about the coupling shaft 182 coupled to the hinge link. According to the present disclosure, convenience in manufacturing the hinge assembly 100 may be improved.

A distance from the coupling shaft 182 to the deviation prevention portion 143 may be shorter than a distance from the coupling shaft 182 to the engaging portion 142. According to the present disclosure, even if a length at which the deviation prevention portion 143 protrudes from the locking body 141 is not designed to be excessively long, the deviation prevention portion 143 may interfere with the door bracket 120 by moving only a short distance. Also, even if a length at which the engaging portion 142 protrudes from the locking body 141 is not designed to be excessively long, the engaging portion 142 may be efficiently prevented from deviating from the insertion portion 114.

The deviation prevention portion 143 may include a plurality of deviation prevention portions 143a and 143b disposed to be spaced apart from each other. The locking member may include a plurality of extension portions 141aa and 141ab extending from the plurality of deviation prevention portions to the engaging portion 142, respectively. The engaging portion 142 may connect the plurality of extension portions to each other.

The engaging portion 142-1 may include a plurality of engaging portions 142a-1 and 142b-1 separated from each other. The locking member 140-1 may include a plurality of extension portions 141aa-1 and 141ab-1 extending from the plurality of engaging portions, respectively, toward the deviation prevention portion. The deviation prevention portion 143-1 may connect the plurality of extension portions to each other.

A cooking apparatus 1 according to an embodiment of the present disclosure may include a main body 10 forming a cooking chamber 20, a door 30 configured to open and close the cooking chamber, and a hinge assembly 100 which connects the main body and the door. The hinge assembly may include a door bracket 120 coupled to the door, a main body bracket 110 coupled to the main body, and a hinge link 130 configured to connect the door bracket and the main body bracket and support the door bracket such that the door bracket is rotatable relative to the main body bracket, and having at least a portion 131 accommodated in the main body bracket. The main body bracket 110 may include a protrusion portion 113 formed to protrude toward the at least a portion 131 of the hinge link accommodated in the main body bracket to prevent the hinge link 130 from moving. According to the present disclosure, the main body bracket 110 may prevent the hinge link 130 from moving and prevent the door from deviating from a designed position by including the protrusion portion 113. In addition, the protrusion portion 113 may improve external quality of a product by preventing the door from deviating from the designed position.

The door bracket 120 and the main body bracket 110 may be arranged to face each other in a first direction X. The protrusion portion 113 may be provided to prevent the hinge link 130 from moving in a second direction Y orthogonal to the first direction.

The main body bracket may further include a cover portion 111 provided to cover the at least a portion 131 of the hinge link accommodated in the main body bracket. The protrusion portion 113 may protrude from the cover portion 111 and be disposed to be spaced apart from one end of the cover portion 111 on the door bracket 120 side. At least a portion of the cover portion 111 positioned between the one end of the cover portion 111 on the door bracket 120 side and the protrusion portion 113 may be spaced apart from the hinge link 130. According to the present disclosure, in a process of coupling the hinge link 130 and the main body bracket 110, the main body coupling portion 131 may be easily inserted into the main body bracket 110.

The protrusion portion may include an inclined surface 113a extending to become close to the hinge link as the inclined surface becomes away from the door bracket. According to the present disclosure, the inclined surface 113a may guide a movement of the main body coupling portion 131 so that the main body coupling portion 131 may be easily inserted into the main body bracket 110 in the process of coupling the hinge link 130 and the main body bracket 110.

The inclined surface may be a first inclined surface, and the protrusion portion may further include a second inclined surface 113b extending to become away from the hinge link as the second inclined surface becomes away from the door bracket, and a contact surface 113c provided between the first inclined surface and the second inclined surface and provided to come into contact with the hinge link. According to the present disclosure, the contact surface 113c may support the hinge link 130 and restrict a movement of the hinge link 130. In addition, the contact surface 113c may distribute a load that the protrusion portion 113 receives from the hinge link 130.

The protrusion portion 113 may include a pair of the protrusion portions arranged to face each other. A distance between the pair of protrusion portions 113 may correspond to a thickness of at least a portion 131 of the hinge link accommodated in the main body bracket.

The pair of protrusion portions 113 may be arranged in a left-right direction of the main body. One protrusion portion of the pair of protrusion portions may be in contact with a left side of the hinge link. The other protrusion portion of the pair of protrusion portions may be in contact with a right side of the hinge link.

A cooking apparatus 1 according to an embodiment of the present disclosure may include a main body 10 forming a cooking chamber 20, a door 30 configured to open and close the cooking chamber, and a hinge assembly 100 which connects the main body and the door. The hinge assembly may include a door bracket 120 coupled to the door, a main body bracket 110 coupled to the main body, a hinge link 130 configured to connect the door bracket and the main body bracket and support the door bracket such that the door bracket is rotatable relative to the main body bracket, a first supporter 171 configured to support one side of the hinge link to prevent the hinge link 130 from rotating in a first direction m1 relative to the main body bracket, and a second supporter 172 configured to support another side of the hinge link to prevent the hinge link 130 from rotating in a second direction m2 opposite to the first direction relative to the main body bracket. According to the present disclosure, the hinge assembly 100 may be configured such that the hinge link 130 is stably supported relative to the main body bracket 110 by including the first supporter 171 and the second supporter 172. In addition, the hinge assembly 100 may be configured to prevent noise or vibration from occurring due to a movement of the hinge link 130 when the door 30 rotates relative to the main body 10, by including the first supporter 171 and the second supporter 172.

At least a portion 131 of the hinge link may be provided to be accommodated in the main body bracket 110. The main body bracket may include a link support portion 115 provided at one end of the main body bracket on the door bracket side to support a lower side of the hinge link. The first supporter 171 may support the at least a portion 131 of the hinge link accommodated in the main body bracket on an upper side. The second supporter 172 may support the at least a portion 131 of the hinge link accommodated in the main body bracket on the lower side.

According to the present disclosure, a hinge assembly of a cooking apparatus can stably support a door by including a locking member configured to fix a door bracket in a position when the door closes a cooking chamber.

According to the present disclosure, a locking member provided in the hinge assembly of the cooking apparatus can be firmly fixed to a main body bracket by including an engaging portion engaged with and coupled to the main body bracket, and efficiently prevent the door from deviating from a designed position by fixing the door bracket in the position when the door closes the cooking chamber.

According to the present disclosure, the locking member provided in the hinge assembly of the cooking apparatus can prevent the engaging portion from being separated from the main body bracket by including a deviation prevention portion provided to prevent the engaging portion from deviating from the main body bracket, and efficiently prevent the door from deviating from the designed position by fixing the door bracket in the position when the door closes the cooking chamber.

According to the present disclosure, the main body bracket provided in the hinge assembly of the cooking apparatus can prevent a hinge link from moving and prevent the door from deviating from the designed position by including a protrusion portion formed to protrude toward at least a portion of the hinge link accommodated in the main body bracket.

According to the present disclosure, the main body bracket provided in the hinge assembly of the cooking apparatus can prevent the door from deviating from the designed position relative to the main body and improve an external quality of a product by including the protrusion portion formed to protrude toward the at least a portion of the hinge link accommodated in the main body bracket.

According to the present disclosure, the hinge assembly of the cooking apparatus can be configured such that the hinge link is stably supported relative to the main body bracket by including a first supporter supporting one side of the hinge link and a second supporter supporting the other side of the hinge link.

According to the present disclosure, the hinge assembly of the cooking apparatus can prevent noise or vibration from occurring due to a movement of the hinge link when the door rotates relative to the main body by including the first supporter and the second supporter configured to prevent the hinge link from moving relative to the main body bracket.

The foregoing has illustrated and described specific embodiments. However, the scope of the present disclosure is not limited to the specific embodiments described above, and various other embodiments that may be modified or changed by those skilled in the art within the scope of not departing from the gist of the technical idea of the present disclosure specified in the claims will also fall within the scope of the present disclosure.

1. A cooking apparatus comprising:
a main body forming a cooking chamber;
a door configured to open and close the cooking chamber; and
a hinge assembly which connects the main body and the door,
wherein the hinge assembly includes:
a door bracket coupled to the door,
a main body bracket coupled to the main body,
a hinge link that connects the door bracket and the main body bracket, and supports the door bracket so as to be rotatable, and
a locking member coupled to the hinge link, and including:
an engaging portion, and
a deviation prevention portion,
wherein the locking member is configured so that, when the door is positioned to close the cooking chamber:
the engaging portion is engaged with the main body bracket to fix a position of the door bracket, and
to prevent the engaging portion from deviating from the main body bracket, the deviation prevention portion is positioned to interfere with the door bracket based on movement of the engaging portion in a direction away from the main body bracket.

2. The cooking apparatus according to claim 1, wherein
the main body bracket includes an insertion portion, and
when the door is positioned to close the cooking chamber, at least a portion of the engaging portion is inserted into the insertion portion.

3. The cooking apparatus according to claim 2, wherein
when the door is positioned to close the cooking chamber, a distance between the door bracket and the main body bracket is shorter than a distance between an end of the engaging portion in a direction of being inserted into the insertion portion and an end of the deviation prevention portion positioned to interfere with the door bracket.

4. The cooking apparatus according to claim 2, wherein
when the door is positioned to close the cooking chamber:
the locking member is configured to be positioned between a first position in which the engaging portion is maximally inserted into the insertion portion and a second position in which the engaging portion moves in a direction away from the insertion portion, and
the deviation prevention portion is configured to come into contact with the door bracket when the locking member is in the second position.

5. The cooking apparatus according to claim 4, wherein
the deviation prevention portion extends in a direction away from a tip configured to contact the door bracket when the locking member is in the second position.

6. The cooking apparatus according to claim 2, wherein
the locking member includes a locking body coupled to the hinge link, and
the engaging portion protrudes from the locking body toward an inner side of the insertion portion.

7. The cooking apparatus according to claim 1, wherein
the locking member includes a locking body coupled to the hinge link, and
the deviation prevention portion protrudes from the locking body in the direction away from the main body bracket.

8. The cooking apparatus according to claim 1, further comprising:
a coupling shaft coupling the locking member to the hinge link,
wherein the locking member is configured to be rotatable relative to the hinge link about the coupling shaft.

9. The cooking apparatus according to claim 8, wherein
a distance from the coupling shaft to the deviation prevention portion is shorter than a distance from the coupling shaft to the engaging portion.

10. The cooking apparatus according to claim 1, wherein
the deviation prevention portion includes a plurality of deviation prevention portions disposed to be spaced apart from each other,
the locking member includes a plurality of extension portions extending respectively from the plurality of deviation prevention portions to the engaging portion, and
the engaging portion connects the plurality of extension portions to each other.

11. The cooking apparatus according to claim 1, wherein
the engaging portion includes a plurality of engaging portions separated from each other,
the locking member includes a plurality of extension portions extending respectively from a plurality of the engaging portions, toward the deviation prevention portion, and
the deviation prevention portion connects the plurality of extension portions to each other.
